(19) United States
(12) Patent Application Publication
(10) Pub. No.: US 2005/0094171 A1
(43) Pub. Date: May 5, 2005

(54) Color processing device and method of processing color

(75) Inventor: Takayuki Ogasahara, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/974,456

(22) Filed: Oct. 27, 2004

Related U.S. Application Data
(60) Provisional application No. 60/516,123, filed on Oct. 31, 2003.

(30) Foreign Application Priority Data
Sep. 14, 2004 (JP) 2004-267508

(51) Int. Cl. H04N 1/56; H04N 1/60

(52) U.S. Cl. 358/1.9; 358/3.26; 358/518; 358/504

(57) ABSTRACT

The resultant colors of colorants are predicted, a color difference generated due to variations in density is calculated, and the combination of colorants for minimizing the color difference is determined, whereby deterioration of a printed image occurring due to variations in density can be minimized.

This application claims priority from Japanese Patent Application No. 2004-267508 filed Sep. 14, 2004, and U.S. Patent Provisional Application No. 60/516,123 filed Oct. 31, 2003 which are hereby incorporated by reference herein.

### BACKGROUND OF THE INVENTION

1. Field of the Invention

The present invention relates to a color processing device and a method of processing color, and particularly to color processing useful for determination of a combination of colorants or the like.

2. Description of the Related Art

Hitherto, with the enhanced quality of images formed by inkjet printers, it has become more common for works of professional photographers or printing proofs for the works to be printed with inkjet printers. Thus, inkjet printers have been used more frequently. Under such conditions, to realize such high image-quality required by professionals or skillful amateurs, it has been desired to develop colorants that are suitable for increasing the size of the color gamut and minimizing the difference between visually perceived colors, which occurs with different light sources.

Regarding transmissive sheets such as films for silver salt photography or the like, the automatic design of color films using simulation techniques to enhance the image quality, i.e., to increase the size of color gamut, stabilize grey-balance, and so forth has been carried out for a long time. On the other hand, referring to the resulting colors of colorants printed on reflective sheets by inkjet printers, the amounts of individual inks placed on the paper and their calorimetric values (tristimulus values and spectral reflectance) have a significantly non-linear relationship. Thus, it is difficult to predict the resultant colors of colorants with high accuracy. This impedes the development of automatic design techniques using computers.

As described above, it is difficult to simulate the resultant colors of colorants. Thus, to optimize the relationship between the amounts of color inks (hereinafter, referred to as the combination of colorants), it is necessary to form color-patches by utilization of several tens of thousands of combinations of colorants, to measure the colors of the color patches, and to acquire knowledge of the relationship between the combinations of colorants and the calorimetric values. Thus, such methods for developing inks as require the above-described procedure are inefficient. Moreover, the examination results tend to have a large variation, depending on investigators and investigation methods.

In recent years, the resolutions of inkjet printers have been enhanced. The number of nozzles provided in inkjet printers has been increased, resulting in a significant increase in nozzle density. As a result, the temperature of printer heads becomes very high during printing, and the jetting of ink becomes unstable. Thus, problems occur in that stripe-defects and color irregularities are formed in printed images (see Japanese Patent Laid-Open No. 2003-326768).

### SUMMARY OF THE INVENTION

It is an object of the present invention to solve the above-described problems and to determine the combination of dyes with which the quality of an output image can be prevented from being deteriorated, which may occur due to color differences in the image caused by variation of the ink density.

It is another object of the present invention to determine the combination of dyes with which the perception of the same color can be prevented from varying with different light sources.

To achieve the above-described objects, the present invention has the constitution described below.

According to a first aspect of the present invention, there is provided a method of processing color useful for determination of a combination of colorants by which the quality of a printed image can be prevented from being deteriorated due to a color difference generated by variations in density, which comprises; a first step of calculating the resultant colors of colorants; a second step of calculating the color difference generated by the variations in density; and a third step of determining the combination of colorants corresponding to the color difference generated by the variations in density.

According to a second aspect of the present invention, there is provided a method of processing color which comprises: a first step of calculating the resultant colors of colorants; a second step of calculating the spectral reflectance of a color chart to be reproduced with colorants, based on the calculation of the resultant colors of the colorants in the first step; a third step of calculating the difference between the spectral reflectance obtained in the second step and the spectral reflectance of the color chart obtained by a calorimetric method; and a fourth step of determining the combination of colorants in response to the difference.

According to a third embodiment of the present invention, there is provided a method of processing color which comprises: a first step of calculating the resultant colors of colorants; a second step of calculating the spectral reflectance and the first tristimulus values under a first light source of a color chart to be reproduced with colorants, based on the calculation of the resultant colors of the colorants in the first step; a third step of calculating the second tristimulus values under a second light source of the color chart to be reproduced with colorants; a fourth step of calculating the differences between the first tristimulus vales and the second tristimulus values; and a fifth step of determining the combination of colorants in response to the difference.

Further objects, features and advantages of the present invention will become apparent from the following description of the preferred embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates an ink absorption layer and base paper.

FIG. 2 illustrates an example of gradation patches.

FIG. 3 shows the spectral reflectances of primary-color colorants predicted by the KM model.

FIG. 4 shows the reflectances of the primary-color colorants predicted by the WC model.

FIG. 5 shows the spectral reflectances of the primary-color colorants predicted by the modified KM model.

FIG. 6 shows the color gamuts at L*=70 predicted by the CN, KM, and WC models.

FIG. 7 shows the color gamuts at L*=60 predicted by the CN, KM, and WC models.

FIG. 8 shows the color gamuts at L*=50 predicted by the CN, KM, and WC models.

FIG. 9 shows the color gamuts at L*=40 predicted by the CN, KM, and WC models.

FIG. 10 shows the color gamuts at L*=70 predicted by the CN and modified KM models.

FIG. 11 shows the color gamuts at L*=60 predicted by the CN and modified KM models.

FIG. 12 shows the color gamuts t L*=50 predicted by the CN and modified KM models.

FIG. 13 shows the color gamuts at L*=40 predicted by the CN and modified KM models.

FIG. 14 illustrates a relationship between the variation of printed ink amounts and the densities.

FIG. 15 shows the spline function.

FIG. 16 is a flow chart illustrating the modified Powell method.

FIG. 17 is a flow chart showing simulation (color processing) for optimizing the combination of colorants in Example 1.

FIG. 18 a block diagram showing an example of the configuration of a computer system.

FIG. 19 is a flow chart showing simulation for determining the combination of colorants by which the color gamut is maximized in Example 2.

FIG. 20 is a flow chart showing an example of the procedure for determining a starting point.

FIG. 21 is a flow chart showing color-matching using the Simplex method.

FIG. 22 illustrates a local minimum.

FIG. 23 illustrates a flow chart showing an example of the procedure for searching for the boundary of color gamut according to the “both-sides attacking” method.

FIG. 24 is a flow chart showing an example of the procedure for depicting a color gamut from a point on the color gamut boundary.

FIG. 25 illustrates a point on the color gamut boundary which is determined by the above-described searching for a color gamut boundary.

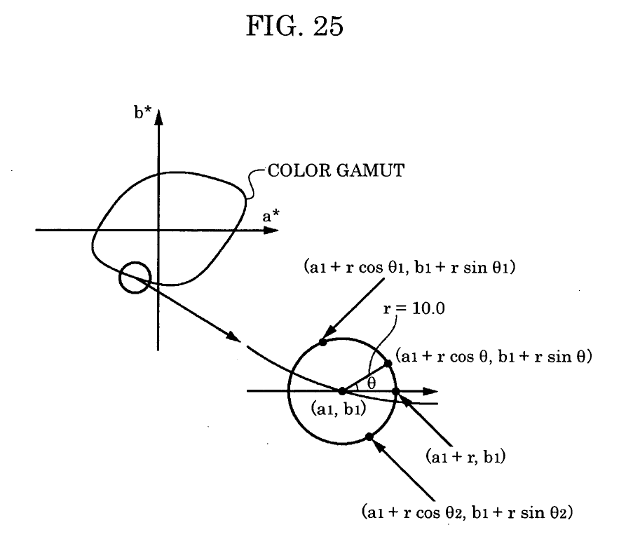

FIG. 26 illustrates the definition of the spectral densities (shape) of colorants.

FIG. 27 illustrates the peak positions and the half-widths.

FIG. 28 is a flow chart showing an example of the procedure for selecting the combination of colorants by which the color gamut is maximized.

FIG. 29 illustrates the definition of the spectral densities (shape) of colorants in Third Embodiment 3.

FIG. 30 is a flow chart showing an example of the procedure for selecting the combination of colorants by which the color gamut is maximized.

FIG. 31 is a flow chart showing an example of the procedure for determining a starting point and an end point in the modification of Prediction Formula 4.

FIG. 32 illustrates examples of the starting point and the end point.

FIG. 33 is a flow chart showing an example of the procedure for depicting a color gamut according to the modification of Prediction Formula 4.

FIG. 34 illustrates two points on a color gamut boundary.

FIG. 35 is a flow chart showing the processing of the Fourth Embodiment.

FIG. 36 illustrates the Macbeth color chart.

FIG. 37 is a flow chart showing the processing in accordance with Prediction Formula 7.

FIG. 38 is a flow chart of the processing in Example 5.

FIG. 39 illustrates a grey scale.

FIG. 40 is a flow chart showing the processing in accordance with Prediction Formula 9.

### DESCRIPTION OF THE PREFERRED EMBODIMENTS

Hereinafter, the color processing according to an embodiment of the present invention is described in detail with reference to the drawings.

### First Embodiment

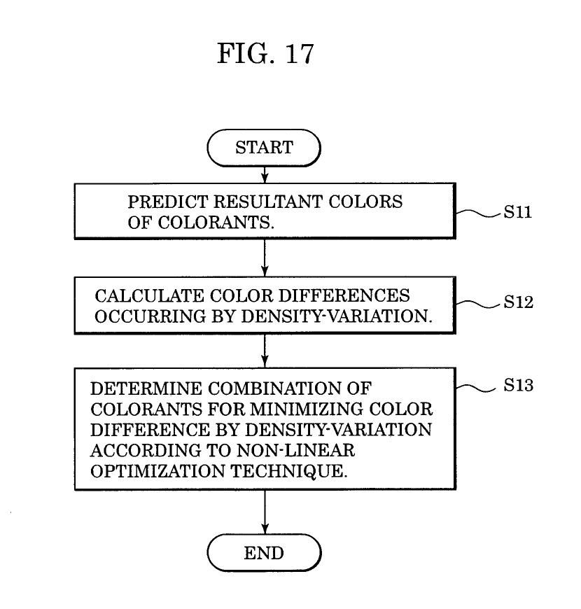

In the First Embodiment, the combination of three-color colorants is determined by which stripe-defects and color irregularities, which are generated in a printed image by variations in density, can be suppressed to the smallest possible level. In other words, simulation (color processing) for optimizing the combination of colorants is described. FIG. 17 is a flow chart showing the simulation.

First, the resultant colors of colorants are predicted in accordance with Prediction Formula 1. Specifically, for each combination of colorants (printed ink amounts), the tristimulus values or the spectral reflectances are predicted (S11).

The above-described stripe-defects or color irregularities formed in a printed image, which occur due to variations in density, are observed when a color difference is not less than a predetermine value. The color difference generated by variations in density is calculated in accordance with Prediction Formula 2 (S12).

The combination of colorants by which the color difference generated by variations in density is minimized is determined in accordance with Prediction Formula 3 (non-linear optimizing technique) (S13). Prediction Formulae 1, 2, and 3 are described in detail below.

Prediction Formula 1

A printer model with which the resultant colors of colorants can be predicted with high accuracy was investigated. Conditions for the investigation, the printer model which is the subject of the investigation, a method for the investigation, and results of the investigation are as follows:

Conditions for Sides Investigation

ink jet printer: printing resolution 1200 dpi×1200 dpi, number of nozzles 512, and jetting amount 4 picoliters
inks: cyan (C), magenta (M), and yellow (Y)
media: Professional Photo Paper (coated paper)
calorimeter: spectrophotometer (manufactured by GretagMacbeth Co., Ltd.)
   Printer Model

Referring to a first printer model, the spectral reflectance R_{λ}(λ) of a combination of colorants according to equations (1) and (2) of the Kubelka-Munk theoretical equation (hereinafter, referred to as KM model) is given by
R_{λ}(λ)=R_{λ,p}(λ)·exp {−2(Σᵢcᵢk_{λ,i})} (1)
k_{λ,i}=−0.5·ln {R_{λ,i}(λ)/R_{λ,p}(λ)} (2)
wherein R_{λi}(λ) represents the spectral reflectance of a primary-color colorant,
R_{λ,p} represents the spectral reflectance of recording-paper,
c represents the density of the primary-color colorant (corresponding to a printed ink amount),
k is the absorption coefficient of the primary-color colorant, and
i is a primary-color colorant, that is, C (cyan), M (magenta), or Y (yellow).

As described in Conditions for Investigation, the primary-color colorants are three-color colorants (inks), i.e., C (cyan), M (magenta), and Y (yellow) colorants (inks). Light-color type colorants such as light-cyan and light-magenta, and special color colorants such as green and orange colorants may be added, if necessary.

Referring to a second printer model, the spectral reflectance R′_{λ,i}(λ) of a primary-color colorant taking account of dot gain can be predicted by equations (3), (4), and (5) of the modified Kubelka-Munk theoretical equation, as follows:
D′_{λ,i}(λ)=1.0−{1.0−D_{λ,i}(λ)}^{b} (3)
b=f(c) (4)
R′_{λ,i}(λ)=10^{-t}, t=D_{λ,i}(λ) (5)
wherein D_{λ,i}(λ) represents the spectral density of a primary colorant,
D_{λ,i}(λ) represents the spectral density of the primary colorant obtained after correction for dot-gain,
c represents the density of the primary colorant (equivalent to the printed ink amount), and
i represents a primary-color colorant, i.e., C, M, and Y.

The dot gain is corrected in accordance with equations (3) to (5). Then, R′_{λ,i} is substituted for R_{λ,i} of equation (2). Thus, the spectral reflectance of a combination of the colorants can be predicted in accordance with equations (1) and (2).

Referring to a third printer model, the spectral reflectance R(λ) of base paper can be predicted by theoretical equation (6) proposed by Williams and Clapper (hereinafter, referred to as the WC model), as follows:

R(λ)0.193T^{2.13}[{½R_{B}(λ)}−∫ᵢ^{n/2}T^{2 secθ}r_{θ}sin θ cos θdθ]⁻¹ (6)

wherein T represents the spectral transmittance of an ink absorption layer (reflects the characteristic of a colorant),

R_{B}(λ) is the spectral reflectance of the base paper,
θ represents the reflection angle of light reflected from the base paper, and
r_{θ} represents the internal Fresnel reflectance with respect to the reflection angle.

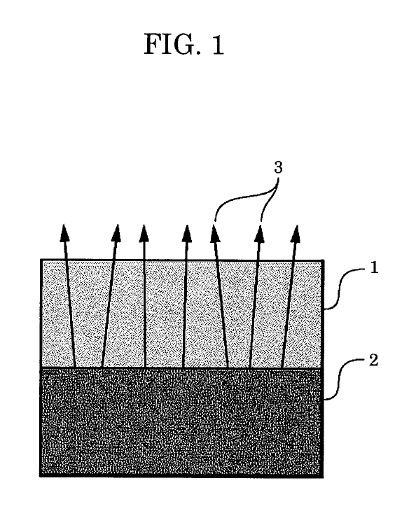

In this case, the refractive index is set at 1.53. This index is changed depending on the type of recording paper (coating materials). For example, in the case where the coating material is titanium dioxide, the refractive index is set in the range of 2.55 to 2.70. For other coating materials, the indexes are set at about 1.5. The ink absorption layer is a recording-paper layer 1 in which ink is absorbed, as shown in FIG. 1. The base paper is the upper surface (base surface) of a recording-paper layer 2 beneath the ink absorption layer 1, and the ink cannot reach the upper surface. Arrows with reference numeral 3 in FIG. 1 represent rays reflected from the base paper. Accordingly, the spectral reflectance R_{λ}(λ) of a combination of the colorants can be expressed by equation (7):
R_{λ}(λ)=R_{λ,p}(λ)R(λ) (7)
wherein R_{λ,p} represents the spectral reflectance of the recording paper.
Investigation Method

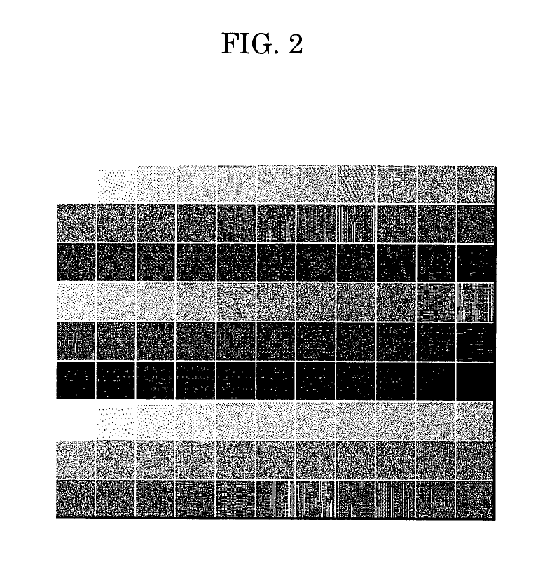

The spectral reflectances of primary-color colorants were predicted by using the above-described printer models. The color differences between the spectral reflectances and the calorimetric values of 33-step gradation patches (see FIG. 2) of the respective CMY colors were determined.

The color gamuts of the primary-color colorants at four lightnesses, i.e., L*=40, 50, 60, and 70, were predicted by using the above-described printer models. The color gamuts were compared with the prediction results obtained by the Cellular Neugebauer model (hereinafter, abbreviated to CN model) whose the prediction accuracy is high.

Investigation Results

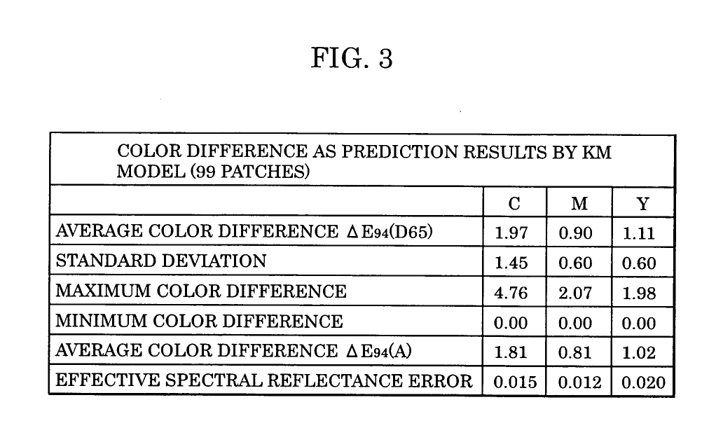

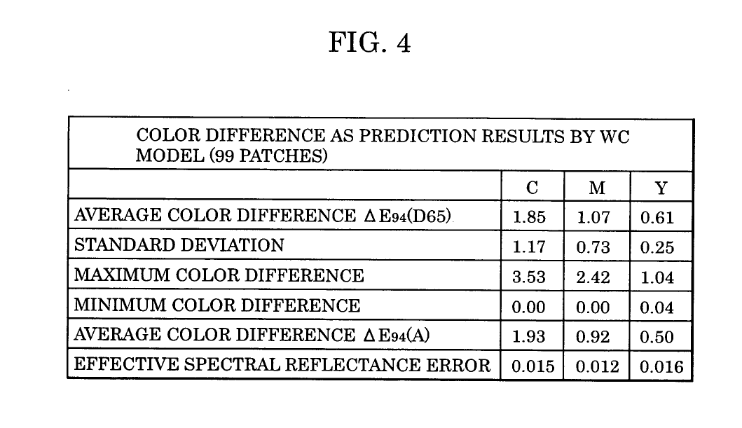

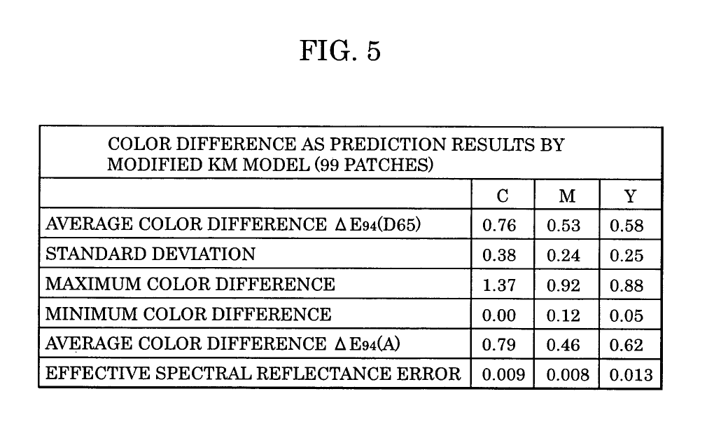

FIGS. 3 to 5 show the spectral reflectances of the primary-color colorants predicted according to the respective printer models, and the color difference between the spectral reflectances and the calorimetric values of the gradation patches shown in FIG. 2.

In general, for image processing such as color matching or the like, desirably, the average color difference ΔE₉₄ is less than 1.0, and the effective spectral reflectance error is less than 0.015. In the case of the KM model and the WC model, for C, the average color difference ΔE₉₄ is larger than 1.0, and the effective spectral reflectance error is equal to 0.015. These results are unsatisfactory. On the other hand, in the case of the modified KM model, the average color difference ΔE₉₄ is less than 1.0, and the effective spectral reflectance error is less than 0.015. These results are satisfactory. The average color difference ΔE₉₄ and the effective spectral reflectance error RMSobj are defined by equations (8), and (9), respectively:
ΔE₉₄=√{(ΔL*/S_{I})²+(ΔC*_{ab}/S_{C})²+(ΔH*_{ab}/S_{H})²} (8)
wherein SI=1,
S_{C}=1+0.045C*_{ab}
S_{H}=1+0.015C*_{ab}
   RMSobj=√{Σ(Rλ−R′λ)²/31 } (9)
   wherein λ=400, 410, . . . , 700 nm (total 31 wavelengths).

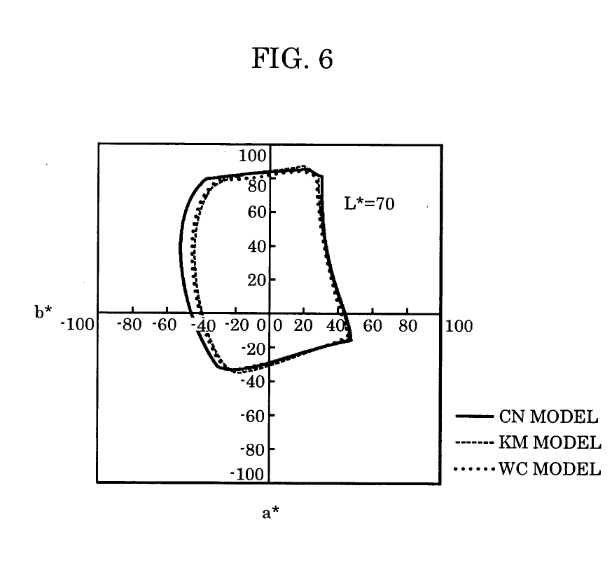

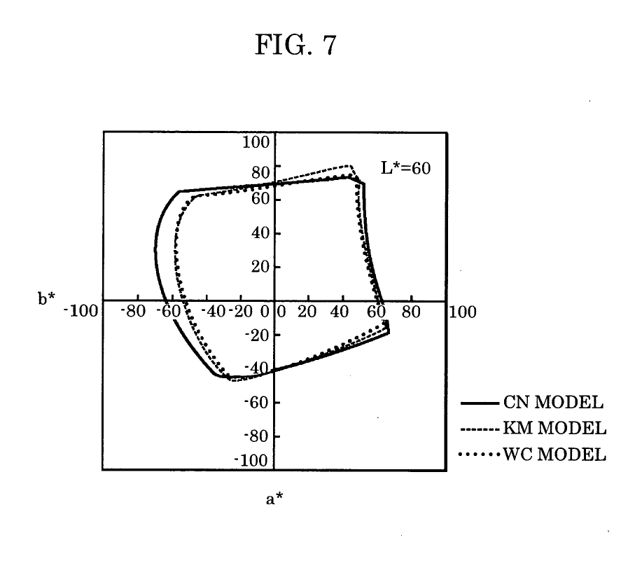

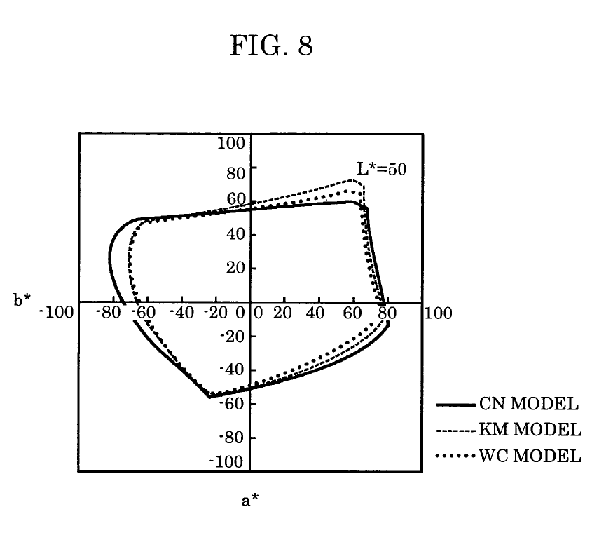

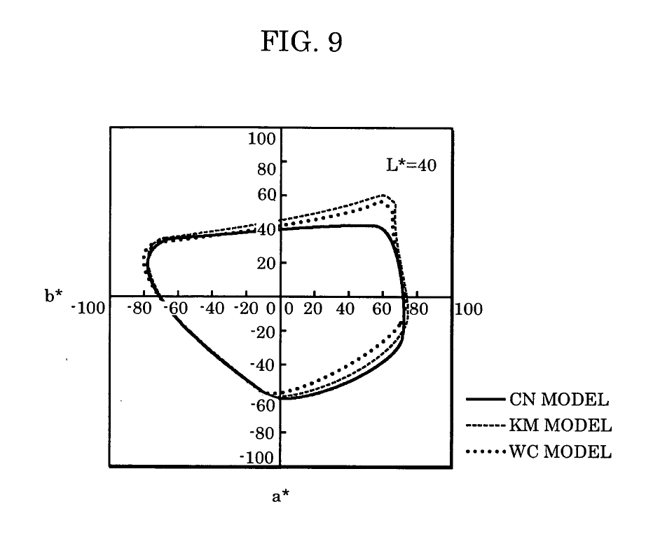

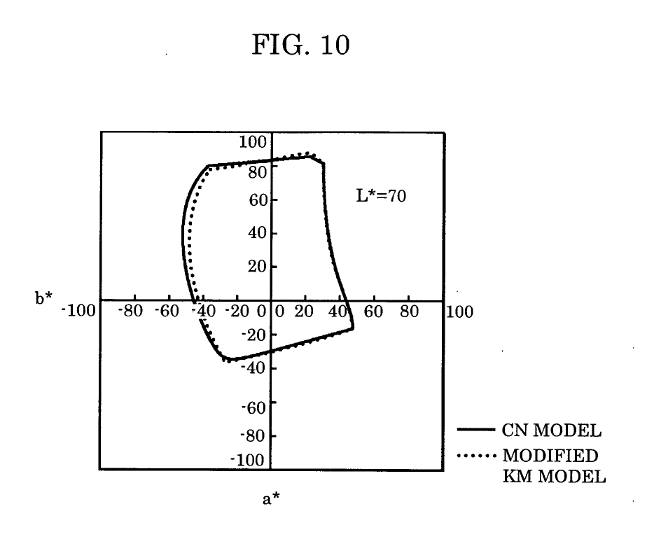

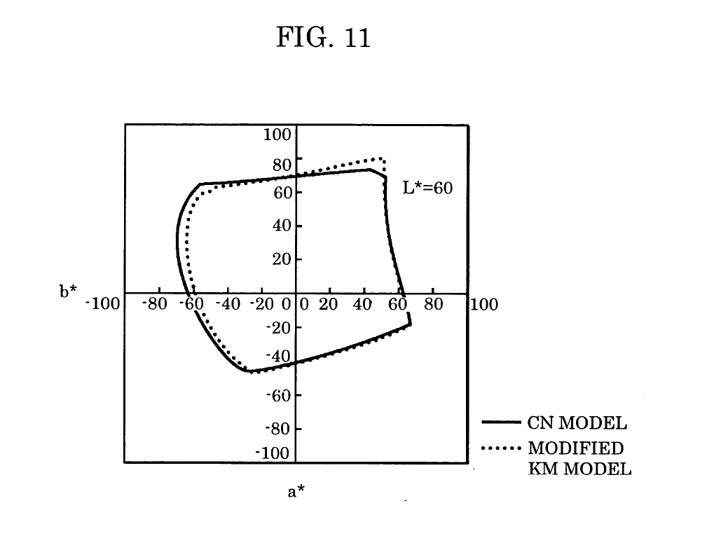

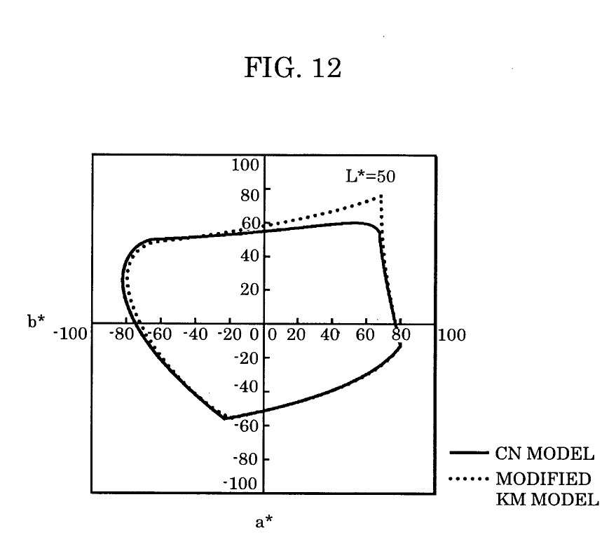

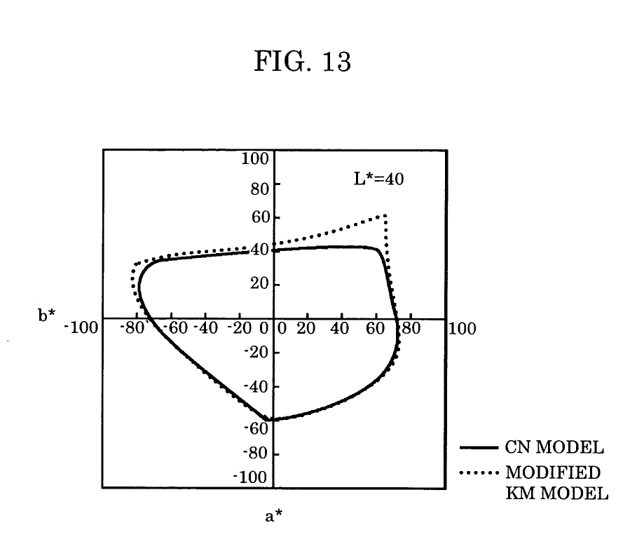

FIGS. 6 to 9 show the color gamuts at L*=70, 60, 50, and 40 predicted according to the CN model (solid line), the KM model (broken line), and the WC model (dotted line). FIGS. 10 to 13 show the color gamuts at L*=70, 60, 50, and 40 predicted according to the CN model (solid line) and the modified KM model (dotted line).

As seen in FIGS. 6 to 9, the color gamuts predicted according to the KM model and the WC model are substantially coincident with those predicted according to the CN model. Thus, as a whole, this shows that the color gamuts can be satisfactorily predicted. As seen in FIGS. 10 to 13, the color gamuts predicted according to the modified KM model are coincident with those predicted according to the CN model except for a part of the color gamuts. Thus, it may be concluded that the color gamuts can be predicted substantially accurately.

However, in the first embodiment, it is more important to determine the combination of colorants for which the color gamuts are maximized, by means of parameters such as the peak positions and the half-widths of the respective colors, than to acquire knowledge of absolute prediction-accuracies, such as the average color difference <1.0, the effective spectral reflectance error <0.015, and so forth. Moreover, regarding actual products, the printing performances varies more or less every time printing is carried out, depending on the differences of individual printer heads, the condition of the paper surface, and so forth. Considering these facts, it may be concluded that the color gamuts of a combination of colorants can be predicted according to the modified KM model, the KM model, and the WC model. Therefore, the modified KM model, the KM model, and the WC model are employed for Prediction Formula 1.

Prediction Formula 2

As described above, stripe defects and color irregularities are generated (observed) in a printed image due to variations in density, when the color difference is not less than a predetermined value. Prediction Formula 2 is provided for determination of the color difference which occurs due to variations in density. The Prediction Formula 2 is composed of the following three elements:
(a) determination of the width of the density-variation,
(b) calculation of the tristimulus values with respect to the maximum density of a colorant plus the width of the density-variation (maximum and minimum values), and
(c) calculation of the color difference between the maximum and minimum tristimulus values.
   Mechanism of Generation of Color Irregularities

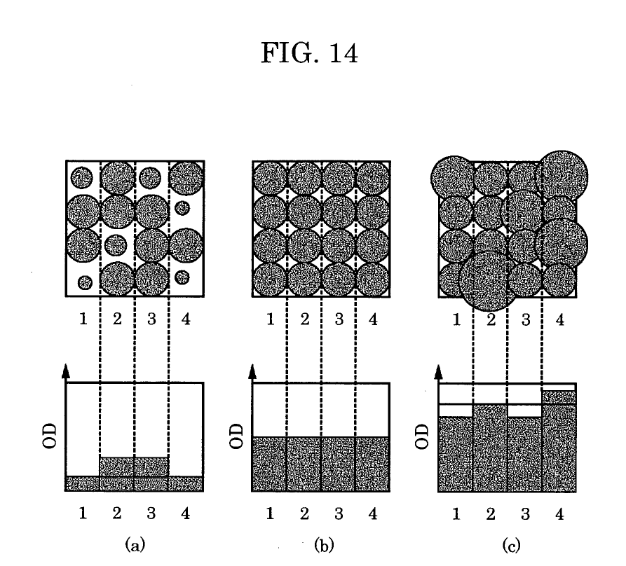

The size of liquid droplets has been reduced to be extremely small, i.e., less than 2 picoliters, and the number of nozzles has been increased with the development of one-inch heads. The density of nozzles has been drastically increased to realize high resolution images having a resolution of 4800 dpi×2400 dpi. Thus, it has been very difficult to stabilize the amount of jetted ink. As shown in FIGS. 14A, 14B, and 14C, the jetting-state of ink becomes unstable, and the amount of jetted ink varies. Thus, the size of dots on the paper is changed. As a result, the average density changes even though the same number of dots are formed. This variation of the average density is recognized in the form of stripe defects and color irregularities, when the dots are visually observed from a distance by a person. FIG. 14A shows the state of dots when the amount of jetted ink is reduced. FIG. 14B shows the state of dots when the amount of jetted ink is kept at its ideal level. FIG. 14C shows the state of dots when the amount of jetted ink is increased.

The width of density-variation is represented by a. Thus, the maximum density is represented by ODmax±a. ODmax represents the maximum density obtained when the arrangement of dots is ideal. The width a may be empirically set based on the calorimetric values of printed images having stripe-defects or color irregularities formed therein. Moreover, the width a of the density variation may be set as a target value.

Approximation of Spectral Density of Colorants by Spline Function

The spectral density (shape) of a colorant is defined by measurement, e.g., at intervals of 10 nm in the wavelength range for the human visual sense, i.e., in a wavelength range of 400 nm to 700 nm. Thus, the spectral density is composed of the densities measured at a total of 31 wavelengths (λ=400, 410, . . . , 700 nm). For one combination of colorants, it is necessary to define the spectral densities S₁(λ), S₂(λ), S₃ (λ) of the three colorants. Moreover, the spectral density of a colorant may be defined by measurement at intervals of, e.g., 5 nm in a relatively wide wavelength range, e.g., 380 to 780 nm.

A method of defining the spectral density of a colorant according to a spline function is described below.

First, it is assumed that the spectral densities of a colorant have positive values. Moreover, it is assumed that the shape of S(λ) is realistic and smooth. Furthermore, it is assumed that there is a single peak in S(λ).

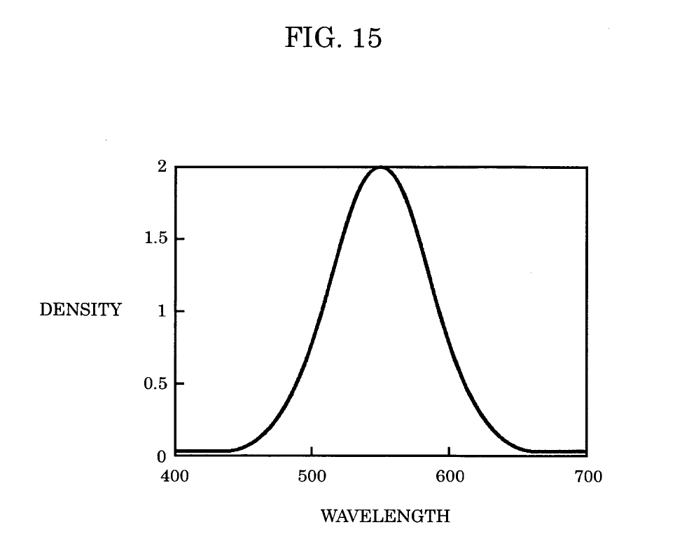

The spectral density of a colorant is defined in accordance with the spline function represented by equation (10). FIG. 15 illustrates the spline function defined by equation (10):
In the case of |λ|≦ω,
C(λ)={(ω³+3ω²(ω−|λ|)+3(ω−|λ|)²+3(ω|λ|)³}/6ω³
In the case of ω<|λ|≦2ω,
C(λ)=(2ω−|λ|)/8ω³
In the case of 2ω<|λ|,
C(λ)=0 (10)
wherein ω represents the half-width, that is, a factor of determining the width of the spectral density, and
λ represents the wavelength (nm).

The spectral density is normalized to a maximum density of 1.0.

The peak position is represented by λ₀ [nm]. Then, the spectral density S(λ) is defined by equation (11) using the spline function C(λ):
S(λ)=C(λ−λ₀) (11)

Thus, the peak positions are represented by λ_{1.0},λ_{2.0}, and λ_{3.0}. The spectral densities of the respective colors are defined by the following equations:
S₁(λ)=C(λ−λ_{1,0})
S₂(λ)=C(λ−λ_{2,0})
S₃(λ)=C(λ−λ_{3,0}) (12)
wherein 400≦λ_{1,0}<λ_{2,0}<λ_{3,0}≦700.

The spectral densities of the respective colorants defined by equation (12) are multiplied by the maximum density ODmax±a, which takes account of the width a of the density variation. Thus, equations (13) and (14) are obtained:
S₁(λ)=c(λ−λ_{1.0})×(ODmax−a)
S₁(λ)=c(λ−λ_{2.0})×(ODmax−a)
S₁(λ)=c(λ−λ_{3.0})×(ODmax−a) (13)
S₁(λ)=c(λ−λ_{1.0})×(ODmax+a)
S₁(λ)=c(λ−λ_{2.0})×(ODmax+a)
S₁(λ)=c(λ−λ_{3.0})×(ODmax+a) (14)

Then, the reflectance of each combination of colorants is determined under a light source D65 at an angle of view of 2° (equation (15)):
R(λ)=f(S₁(λ), S₂(λ), S₃(λ)) (15)

The tristimulus values are calculated in accordance with equation (16):
X=k∫₄₀₀⁷⁰⁰R(λ)·P(λ)·x(λ)dλ
Y=k∫₄₀₀⁷⁰⁰R(λ)·P(λ)·y(λ)dλ
Z=k∫₄₀₀⁷⁰⁰R(λ)·P(λ)·z(λ)dλ (16)
wherein

$$k = 100 / {\int }_{400}^{700} P ( λ ) \cdot y ( λ ) ⅆ λ ,$$

x(λ), y(λ), and z(λ) represent color matching functions, and
P(λ) represents the spectral distribution of the light source.

### Calculation of Color Difference

The maximums and the minimums of the tristimulus values of the combinations of colorants are determined. Thereafter, the XYZ system of color representation is converted to the LCH system of color representation. The color differences between the maximums and the minimums of the tristimulus values can be calculated using equation (8).

Prediction Formula 3

The prediction formula 3 is used for determination of the combination of three-color colorants for minimizing the color difference generated due to variations in density using a physical model equation (Prediction Formula 1) which represents the resultant colors of colorants and an approximation equation (Prediction Formula 2) for the spectral densities of colorants in accordance with a spline function.

The combination of colorants for minimizing the color difference is determined using the modified Powell method, which is one non-linear optimization technique. In the given below explanation of the non-linear optimization technique, function f corresponds to the color difference determined in accordance with Prediction Formula 2.

As non-linear optimization techniques, the GREG algorithm proposed by Abadie in 1970, a genetic algorithm (GA), immunity-type algorithm (IA), and neural networks may be used. Also, a kind of repetition method by which the optimization is carried out step-by-step in interaction with a computer may be employed. Moreover, a technique by which the optimum solution is determined by round robin calculation may be used.

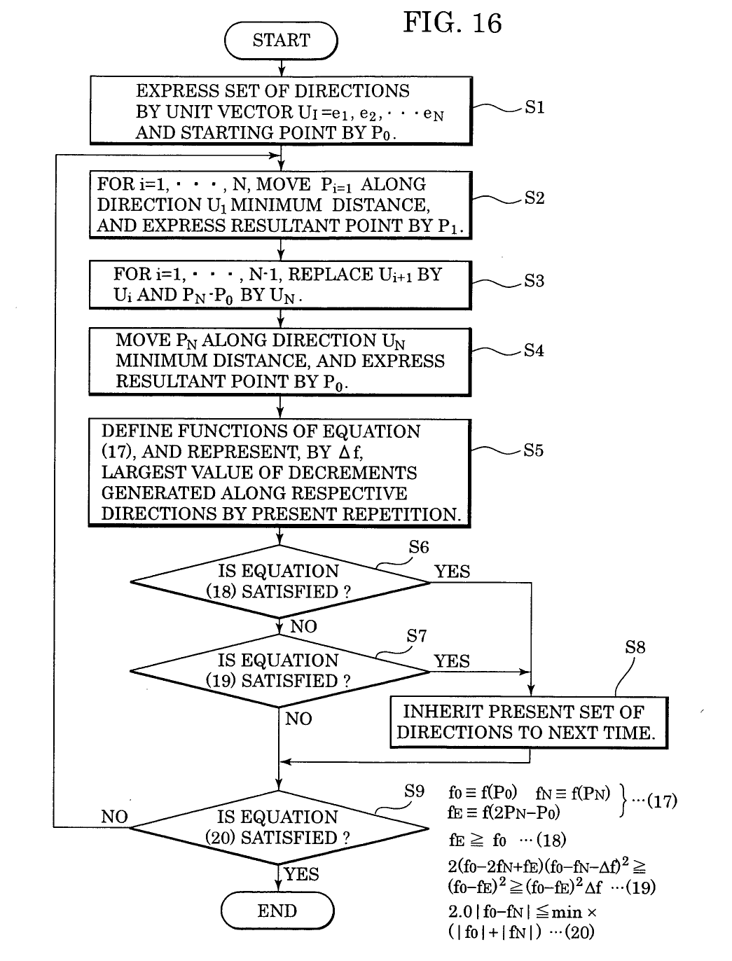

FIG. 16 is a flow chart showing the modified Powell method.

First, as a direction-set, unit vector uᵢ=e₁, e₂, . . . , e_{N} is set (in the case of the CMY three colors). As a starting point, P₀ (the set of parameters ω₁, ω₂, ω₃, λ₁, λ₂, λ₃ in equation (10)) is set (S1). Then, for i=1, . . . , N, Pᵢ₋₁ is moved along direction uᵢ by a minimum distance. The resultant point is expressed by Pᵢ (S2). Subsequently, for i=1, . . . , N−1, uᵢ₊₁ is replaced by direction uᵢ and P_{N}−P₀ is replaced by u_{N} (S3). Then, P_{N} is moved along direction u_{N} by a minimum distance. The resultant point is set as P₀ (S4).

Then, the functions of equation (17) are defined. The largest value in decrements generated along the respective directions by the present repetition is represented by Δf (S5). In this embodiment, the function f of the equation (17) represents the color difference between the combinations of colorants which are defined by equations (13) and (14):
f₀≡f(Pₒ)
f_{N}≡f(P_{N})
f_{E}≡f(2P_{N}−P₀) (17)
wherein f_{E} represents the value of the function when the point is advanced by an excessively small distance along a new direction.

Subsequently, it is determined whether equation (18) is satisfied or not (S6), and then, it is determined whether the equation (19) is satisfied or not (S7). If it is determined that one or both of equations (18) and (19) are satisfied, the present set of directions is inherited to the next operation (S8).
f_{E≧f}₀ (18)
2(fₒ−2f_{N}+f_{E})(fₒ−f_{N}−Δf)²24 (fₒ−f_{E})²≧(fₒ−f_{E})²Δf (19)

Subsequently, it is determined whether the equation (20) is satisfied or not (S9). If it is determined that the equation (20) is satisfied, the processing is terminated. If it is determined that the equation (20) is not satisfied, the processing returns to step S2:
2.01|fₒ−f_{N}|≦min×(|fₒ|+|f_{N}|) (20)
wherein min represents a constant (e.g., 10⁻⁶) for assuring the termination of the operation.
Configuration of Hardware

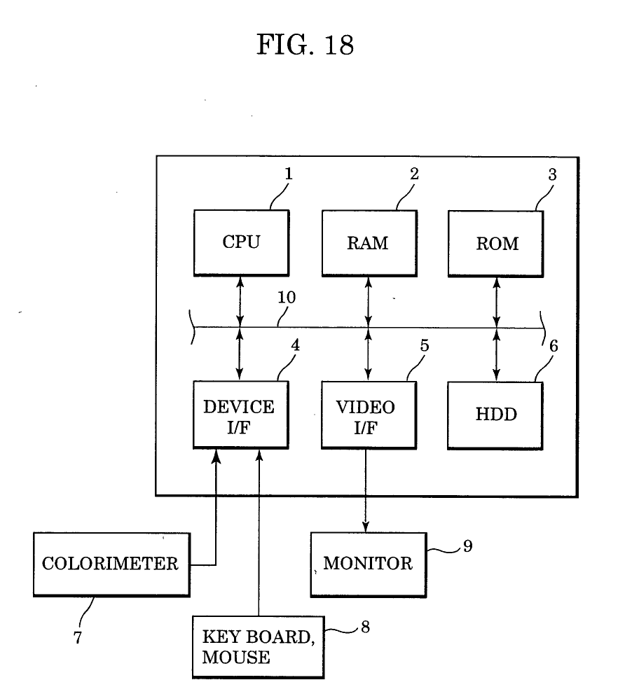

A program for the above-described simulation is supplied to a computer system configured as shown in FIG. 18. Thus, the simulation (color processing) can be executed.

CPU 1 runs a basic IO system (BIOS) stored in ROM 3 and an operating system (OS) and various programs (including programs for the above-described simulation) stored in a hard disk drive (HDD) 6, as work memories, and controls the respective units via a system bus 10.

The CPU 1 causes a monitor 9 to display results processed via a user interface, and results processed according to the various programs via a video interface (I/F) 5. For example, the CPU 1 receives an instruction from a user via a keyboard/mouse 8 connected to a device I/F 4, which is a serial bus interface such as Universal Serial Bus (USB), IEEE1394, or the like.

The CPU 1 causes the monitor 9 to display data showing the combination of colorants obtained as a result of the above-described simulation, causes a printer (not shown) to print the data via the device I/F, or causes a removable media drive (not shown), connected to the device I/F, to record the data.

Moreover, the CPU 1 controls a calorimeter 7 via the device I/F 4, so that calorimetric values of the gradation patches shown in FIG. 2 or the like can be obtained.

As seen in the above-description, according to the first embodiment, the resultant colors of colorants can be simulated. Thus, the conventional work by optimizing the combination of colorants, forming the color patches of several tens of thousands of combinations of colorants, and measuring the colors of the color patches to reveal a relationship between the combinations of colorants and the calorimetric values is unnecessary. Therefore, the combination of colorants that minimizes the deterioration (stripe-defects and color-irregularities) of a printed image, which may occur due to variations in density, can be determined efficiently, with high accuracy, and in a short time.

### Second Embodiment

Hereinafter, color processing according to a second embodiment of the present invention is described. In the second embodiment, the elements having substantially the same constitutions as those in the first embodiment are designated by the same reference numerals. The detailed description is not repeated.

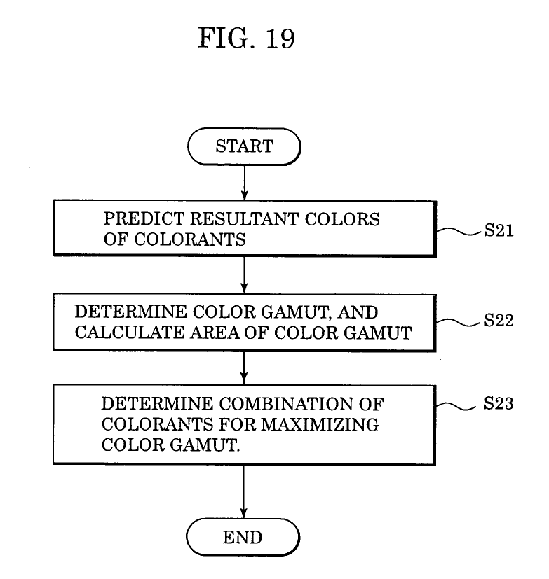

In the second embodiment, the combination of colorants for maximizing the color gamut is determined using simulation (color processing) for optimizing the combination of colorants. FIG. 19 is a flow chart showing the simulation.

First, according to Prediction Formula 1, the resultant colors of colorants, that is, the tristimulus values or spectral reflectance of each combination of the colorants (the amounts of individual inks printed on the paper), is predicted (S21).

Subsequently, the color gamut is determined, and the area is calculated in accordance with Prediction Formula 4(S22).

Then, the combination of the colorants for maximizing the color gamut is determined (S23) in accordance with Prediction Formula 5.

Prediction Formula 1

Prediction Formula 1 employs the modified KM model, the KM model, and the WC model, as in the first embodiment. The detail description is not repeated.

Prediction Formula 4

Prediction Formula 4 is composed of four elements, which are sequentially described below:
(a) Determination of starting point
(b) Searching for color gamut boundary
(c) Depiction of color gamut
(d) Calculation of area of color gamut
   Determination of Starting Point

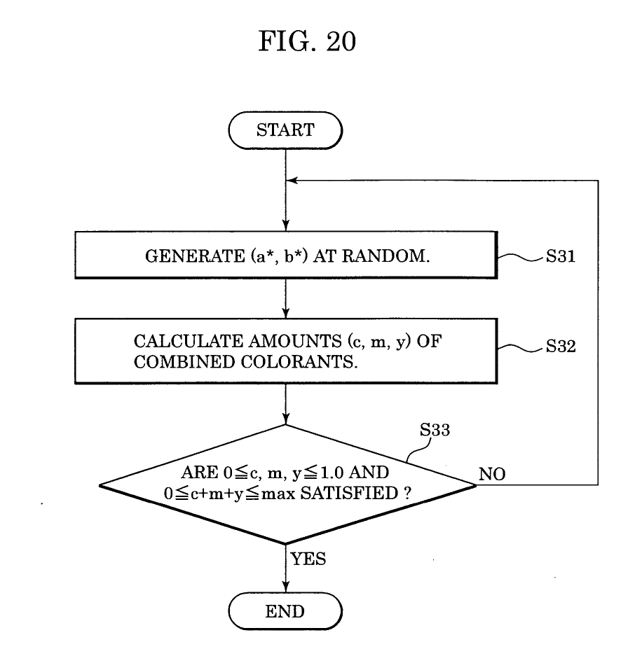

FIG. 20 is a flow chart showing an example of the procedure for determining a starting point.

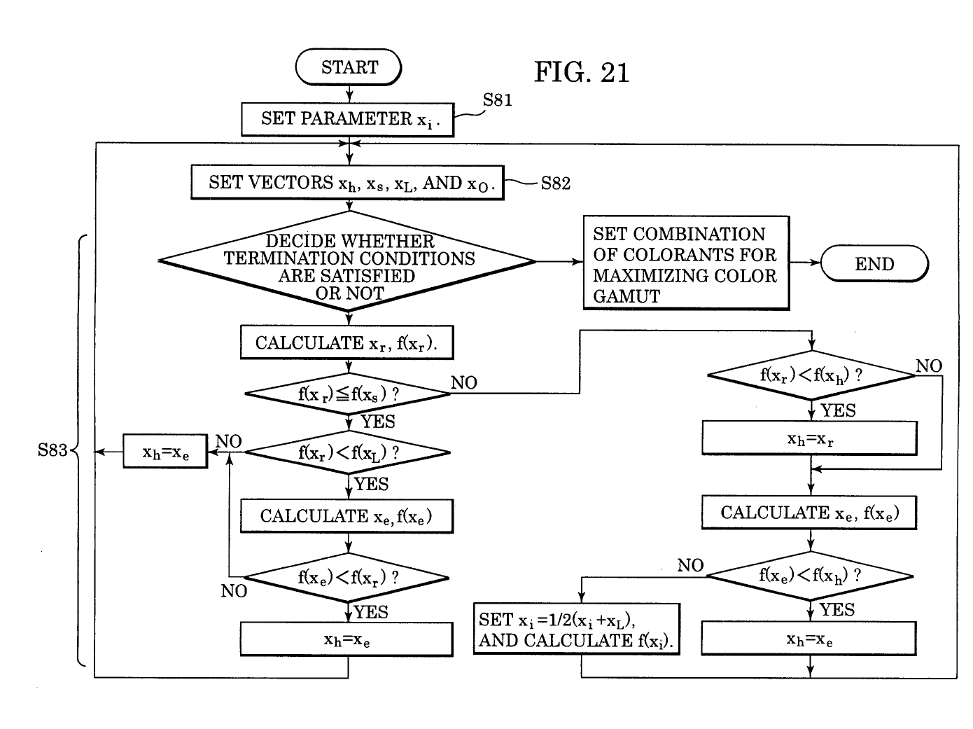

Points (a*, b*) are generated at random on the L* plane on which the color gamut is to be predicted in the CIE LAB color space. With respect to the generated points, the amounts (c, m, y) of combined colorants are determined by a color matching method using the Simplex method shown in FIG. 21 (S32). It is determined whether or not the amounts of the combined colorants satisfy equation (21) (S33). Steps S31 and S32 are repeated until the amounts satisfy equation (21). When a point at which the amounts of the combined colorants satisfy the equation (21) is obtained, the point is taken as a starting point (a0, b0) in the color gamut:
0≦c, m, y≦1.0
0≦c+m+y≦max (21)
wherein max represents the maximum amount of the combined colorants.

As described above, the maximum amount of the combined colorants is set in accordance with equation (21). The reason lies in the fact that if excess amounts of inks are printed on the recording paper, the inks will run or spread, so that the image quality is severely deteriorated.

FIG. 21 is a flow chart showing color matching using the Simplex method. The function f(x) is equivalent to Prediction Formula 1. In the function f(x), x represents the set of parameters (the peak position of the respective colorants or the half-width). The function f(x) represents the area of a color gamut (1/A; A is the area of the color gamut) or the difference between visually perceived colors (differences between reflection spectra or ΔE₉₄).

First, parameter xᵢ is set (S81). In the case of three-color colorants, the parameter xᵢ consists of a total of six parameters, i.e., peak positions λ_{1.0}, λ_{2.0}, and λ3.0 and half-widths ω₁, ω₂, and ω₃. Equation (22) represents the parameters and restriction conditions. The peak position is varied at intervals of 10, and the half-width is varied at intervals of 5.
xᵢ=λ_{i,1.0}, λ_{i,2.0}, λ_{i,3.0}, ω_{i,1}, ω_{i,2}, and ω_{i,3}, (22)
wherein i=1, 2, . . . , 7
400 ≦λ_{1.0}≦500
500 ≦λ_{2.0}≦500
600 ≦λ_{3.0}≦500
5≦ω₁, ω₂, ω₃≦110.

Then, for the optimization of the parameters in the Simplex method, vectors are set as follows:
xₕ=max {f(xᵢ)}(i=1, 2, . . . , n+1)
x_{S}=max {f(xᵢ)}(i≠h)
x_{L}=min {f(xᵢ)}(i=1, 2, . . . , n+1) (23)
x₀=Σxᵢ/n(i≠h, i=1, 2, . . . , n+1)
wherein f(xᵢ)=1/A (A is the area of the color gamut)

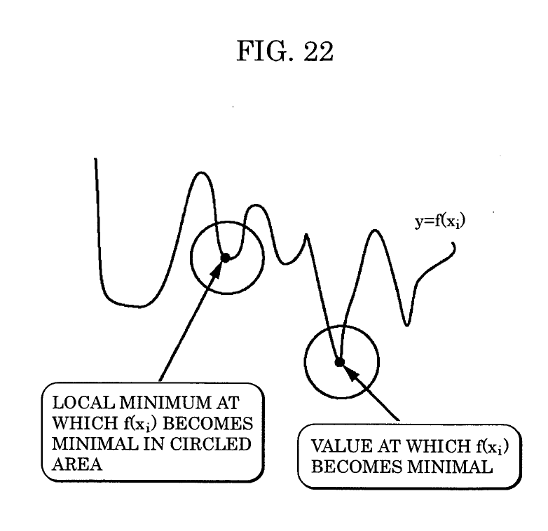

The parameters for minimizing Xₕ of the equation (23) are determined by the Simplex method using equations (23) and (24). If there is possibility of a local minimum shown in FIG. 22 existing, the auxiliary processing described below is executed:
xᵣ=(1+a)x₀−axₕ
x_{E}=βx_{R}+(1−β)x₀ (24)
xₑ=Yxₕ+(1−Y)x₀
wherein a>0, β>0, and Y>0 are coefficients (in this embodiment, a=1, β=2, and Y=½).

If the parameters for minimizing the xₕ are determined, the parameters are substituted into Prediction Formula 1, and the combination of the colorants for maximizing the color gamut is set (S84). If there is possibility of a local minimum existing, the following auxiliary processing is executed:
(1) The range of the peak position is changed, e.g.,
400≦λ_{1.0}≦550
450≦λ_{2.0}≦650
550≦λ_{3.0}≦700
(2) The peak position is varied at intervals of e.g., 20 nm.
(3) The range of the half-width is changed. For example,
40≦ω₁, ω₂, ω₃≦90
(4) The half-width is varied at intervals of, e.g., 10.

The processing results obtained when the above-described auxiliary processing steps (1) to (4) are carried out and the processing results of step S83 (when the auxiliary processing steps are not carried out) are compared to each other. The processing results obtained when xₙ of equation (23) is minimized are adopted.

Searching for Color Gamut Boundary

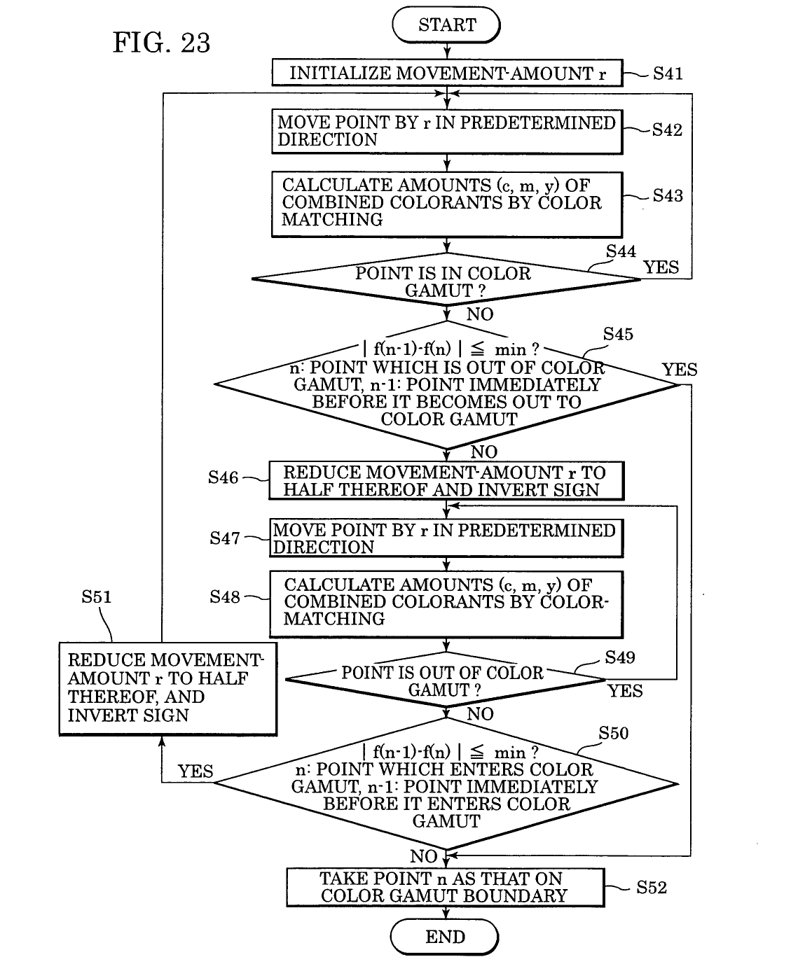

FIG. 23 is a flow chart showing an example of the procedure for searching for a color gamut boundary by a so-called “both-sides attacking” method.

First, the movement amount r is initialized (e.g., r=−10) (S41), and the starting point (a0, b0) is moved by an amount r in the b* direction (S42).

Subsequently, with respect to the point after the movement, the amounts of the combined colorants are determined by the above-described color matching method (S43). It is determined whether the point satisfies equation (21) or not; that is, it is determined whether the point is in the color gamut or not (S44). If the point is in the color gamut, the point is further moved by a movement amount r in the b* direction (S42). That is, steps S42 to S44 are repeated until the point leaves the gamut.

When the point leaves the color gamut, the resultant color f(n) at the point n and the resultant color f(n-1) of the point n-1 at the position immediately before the point leaves the color gamut are determined in accordance with Prediction Formula 1 (y=f(λ)). It is determined whether the difference |f(n)−f(n-1)| is smaller than a constant min (e.g., 10⁻⁶) to ensure the termination of the processing (S45).

If the point exceeds the constant min, the movement amount r is reduced to one half thereof, and the sign is inverted (e.g., r=5 after the reduction) (S46). The point is moved in the b* direction by the movement amount r (S47). With respect to the point after the movement, the amounts of the combined colorants are determined by the above-described color matching (S48). It is determined whether the point satisfies equation (21); that is, it is determined whether the point is out of the color gamut or not (S49). If the point is out of the color gamut, the point is further moved by the movement amount r in the b* direction (S47). In other words, steps S47 to S49 are repeated.

If the point enters the color gamut, the resultant color f(n) at the point n and the resultant color f(n-1) immediately before its entering the color gamut are determined in accordance with Prediction Formula 1 (y=f(λ)). It is determined whether or not the difference |f(n)−f(n-1)| is not more than the constant min (S50). If the difference exceeds the constant min, the movement amount r is reduced to one half thereof, and the sign is inverted (e.g., r=−2.5 after the reduction) (S51). The processing then returns to step S42.

If the difference of the resultant colors is not more than the constant min, depending on the determination at steps S45 and S50, the point n is taken as a point (a0, b1) positioned on the color gamut boundary (S52).

Thus, the procedure for determining a point on the color gamut boundary is described above. The starting point is moved not only in the b* direction (vertical direction) but also in the a* direction (horizontal direction), so that points on the color gamut boundary, which are necessary to depict a color gamut, are determined.

Depiction of Color Gamut

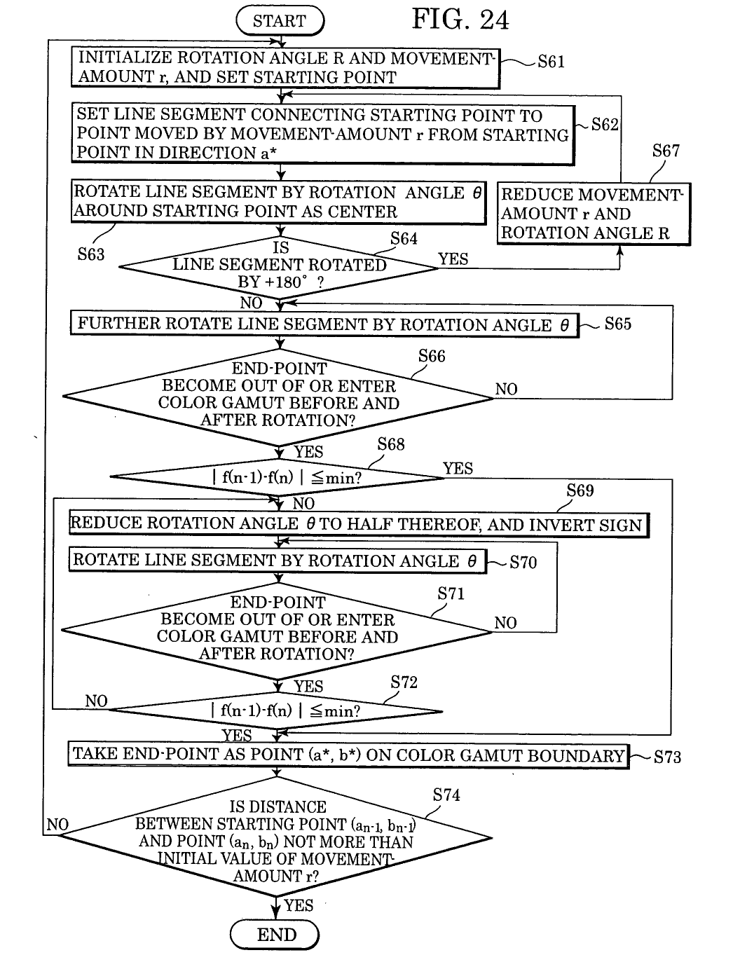

FIG. 24 is a flow chart showing an example of the procedure for depicting a color gamut from a point on the color gamut boundary. In the description below, a point on the color boundary, obtained in the above-described search for a color gamut boundary, is represented by (a1, b1), as shown in FIG. 24.

First, a rotation angle θ and the movement amount r are initialized (e.g., θ=+30°, r=10), and the starting point is set at (a1, b1) (S61). A line segment connecting the starting point (a1, b1) to the point (a1+r, b1) moved from the starting point (a1, b1) by the movement amount r in the a* direction is set (the rotation angle is set at 0) (S62). An end point (a1+r*cos (−90+θ), b1+r*sin (−90+θ) is determined by rotating the line segment around the point (a1, b1), serving as the center, by a rotation angle θ from the position of −90° (the angle obtained when the line segment is rotated by 90° in the clockwise direction) (S63). When the rotation angle is positive, the line segment is rotated in the counterclockwise direction. When the rotation angle is negative, the line segment is rotated in the clockwise direction.

Then, it is determined whether the rotation angle of the line segment reaches +180° or not (S64). If the rotation angle of the line segment has not reached +180°, an end point, which is generated by further rotating the line segment by the rotation angle θ, is determined (S65). Then, it is determined whether the end point leaves the color gamut or enters the color gamut before and after the rotation (hereinafter, referred to as “change of color gamut”) in accordance with the above-described color matching and equation (21). If no change of the color gamut occurs, the processing returns to step S64. Steps S64 and S65 are repeated every time the rotation by an angle θ is carried out until the change of the color gamut occurs.

If it is determined at step S64 that the rotation angle reaches +180°, the movement amount r and the rotation angle θ are reduced (e.g., reduced to one fifth and one third, respectively) (S67), and the processing is returned to step S62.

If the change of color gamut occurs, the resultant colors f(n-1), f(n) at the two end points n-1, n obtained before and after the rotation are determined in accordance with Prediction Formula 1 (y=f(x)). It is determined whether the difference |f(n)−f(n-1)| is not more than the constant min (e.g., 10⁻⁶) for ensuring the termination of the processing (S68).

If the difference exceeds the constant min, the rotation angle θ is reduced to one half thereof, and the sign is inverted (e.g., θ=−15°) (S89). The line segment is rotated by the rotation angle θ (S70). It is determined whether or not the change of color gamut occurs at the end point before and after the rotation (S71). If on change of the color gamut occurs, the processing returns to step S70. Every time the rotation by the rotation angle θ is carried out, steps S70 and S71 are repeated until the change of color gamut occurs.

If the change of color gamut occurs, the resultant colors f(n-1), f(n) at the two end points n-1, n obtained before and after the rotation are determined. It is determined whether the difference |f(n)−f(n-1)| is not more than the constant min (e.g., 10⁻⁶) for ensuring the termination of the processing (S72). If the difference exceeds the constant min, the processing returns to step S69. The rotation angle is reduced to one half thereof, and the sign is inverted (e.g., θ=7.5°).

If it is determined that the difference of the resultant colors is not more than the constant min at steps S68 and S72, the end point is taken as a point (aₙ, bₙ) positioned on the color gamut boundary (S73).

The above-described processing is repeated until the distance L=√{(aₙ, bₙ)²+(aₙ+ₙ)²}, which represents the distance between the starting point (aₙ₋₁, bₙ₋₁) and the end point (aₙ, bₙ) on the color gamut boundary, is not more than the initial value of the movement amount r. If L≦r (initial value), the depicting of the color gamut is terminated. If the processing returns to step S61, the stating point is set at (aₙ, bₙ).

Calculation of Area of Color Gamut

The area A of a triangle can be calculated using the three sides a, b, and c in accordance with equation
(25): A=√{s(s−a)(s−b)(s−c)} (25)

The area A of a polygon defined by the set of points can be calculated in accordance with equation (26), which is derived from the equation (25).
A=(U₀V₁−U₁V₀)+(U₁V₂−U₂V₁)+ . . . +(Uₙ₋₁Vₙ−UₙVₙ₋₁)−Σᵢ₋₁^{m}(uᵢvᵢ₊₁−uᵢ₊₁vᵢ) (26)
wherein (uᵢ, vᵢ) represents a point on the polygon, and (u₀, v₀) represents the point positioned at the left-side end of the polygon.

Therefore, the area A of the polygon formed with the points on the color gamut boundary, obtained by the depiction of the color gamut, can be determined by calculation in accordance with equation (26).

Prediction Formula 5

Formula 5 is composed of the following three elements. These elements are sequentially described below.
(a) Preparation of hypothetical colorants
(b) Calculation of area of color gamut by Prediction Formula 4
(c) Selection of combination of colorants for maximizing color gamut
   Preparation of Colorants

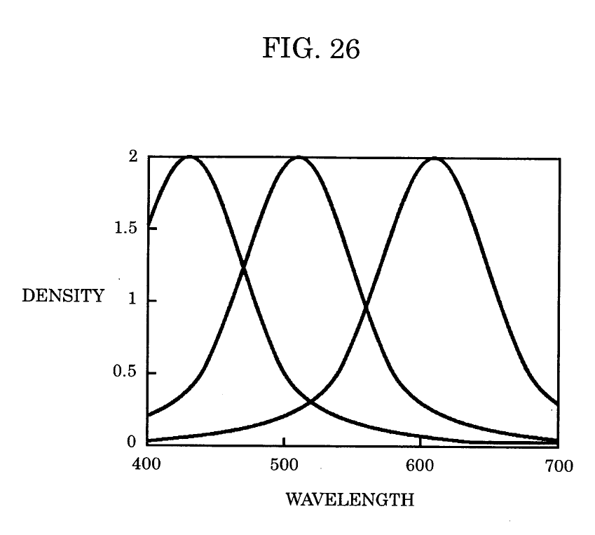

For a colorant, the spectral density (shape) is defined at intervals of 10 nm in the wavelength range of 400 to 700 nm (410, 420, . . . , 700 nm). Accordingly, the total number of the spectral densities of the colorant is 31. For one combination of colorants, it is necessary to define the spectral densities S₁(λ), S₂(λ), and S₃(λ) of the three colorants (see FIG. 26).

Hereinafter, a method of preparing hypothetical colorants in accordance with a spline function is described.

First, all of the spectral densities of colorants are set to be positive. Moreover, it is assumed that the shape of S(λ) is realistic and smooth. The number of peaks of S(λ) is assumed to be one, considering color-separation. The spectral density of a colorant is defined in accordance with the spline function expressed by equation (10). However, in this case, the spectral density is normalized to a maximum density of 2.0, which is different from that of equation (10).

The peak position is represented by λ₀ (nm). Then, the spectral density S(λ) is defined by equation (11) using the spline function C(λ). Thus, the peak positions λ_{1.0}, λ_{2.0}, and λ_{3.0} of the respective colorants are defined by equation (12).

Calculation of Area of Color Gamut by Prediction Formula 4

Regarding the combination of the hypothetical colorants prepared as described above, the color gamuts are determined, and the areas are calculated in accordance with Prediction Formula 4.

Selection of Combination of Colorants for Maximizing Color Gamut

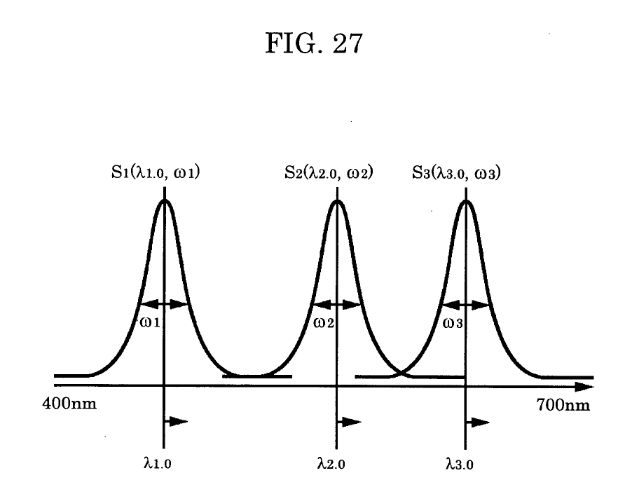

The peak positions λ_{1.0}, λ_{2.0}, and λ_{3.0} and the half-widths ω₁,ω₂, and ω₃ are varied (see FIG. 27). Regarding the respective combinations of the hypothetical colorants, the areas of the color gamuts are calculated. The combination of colorants for maximizing the color gamut is selected. The area of a color gamut is calculated at intervals of L*=10 in the lightness range of L*=40 to L*=90. The sum of the six calculated areas is taken as the area of the color gamut.

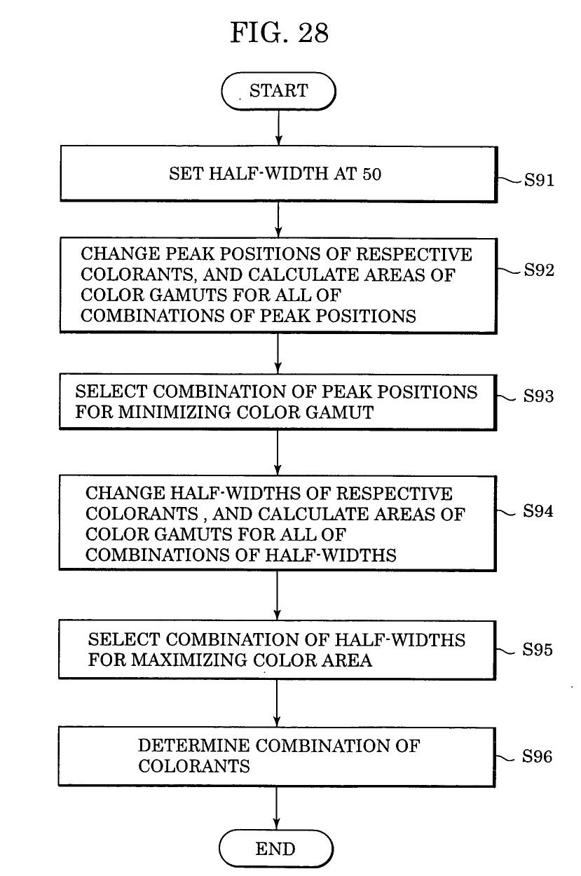

FIG. 28 is a flow chart showing an example of the procedure for selecting the combination of colorants for maximizing the color gamut.

First, the half-widths ω1, ω2, and ω3 are set at ω1=ω2=ω3=50 (S91). The peak positions λ_{1.0}, λ_{2.0}, and λ_{3.0} of the respective colorants are varied, and for all of the combinations of the colorants, the areas of the color gamuts are calculated (S92). It should be noted that the peak position λ_{1.0} is varied in the range of 400 nm to 500 nm at intervals of 10 nm, the peak position λ_{2.0} is varied in the range of 500 nm to 600 nm at intervals of 10 nm, and the peak position λ_{3.0} is varied in the range of 600 nm to 700 nm at intervals of 10 nm.

Then, the combination of the peak positions λ_{max,1.0}, λ_{max,2.0}, and λ_{max,3.0} for maximizing the color gamuts is selected (S93). The half-widths of the respective colorants are varied in the range of 10 to 110 at intervals of 5. For all of the combinations of the half-widths, the areas of the color gamuts are calculated (S94). The combination of the half-widths λ_{max,1.0}, λ_{max,2.0}, and λ_{max,3.0} for maximizing the color gamuts is selected (S95).

Then, the combination of the peak positions λ_{max,1.0}, λ_{max,2.0}, and λ_{max,3.0} selected at step S93 and the combination of the half-widths ω_{max,1.0}, ω_{max,2.0}, and ω_{max,3.0} selected at step S95 are combined with each other to constitute the combination of the colorants for maximizing the color gamut (S96)

The above-described procedure is similar to the round robin calculation method by which all of the combinations are calculated. Thus, the time required for the calculation is very long. However, with the recent technical advancement of computers, the procedure has become more practical. As optimization techniques, a GREG algorithm, the genetic algorithm (GA), an immunity-type algorithm (IA), neural networks, and a kind of repetition method by which the optimization is carried out step-by-step in interaction with a computer, as described above, may be employed, so that the calculation time can be reduced.

Thus, according to the second embodiment, the combination of colorants for maximizing the color gamut can be determined by use of the simulation (color processing) for optimizing the combination of colorants.

### Third Embodiment

Hereinafter, color-processing according to a third embodiment of the present invention is described. In the third embodiment, elements having the same constitutions similar as those in the first and second embodiments are designated by the same reference numerals, and the detailed description is not repeated.

In the third embodiment, the simulation (color processing) described in the second embodiment is applied to the combination of four-color colorants as an example.

According to the simulation of the third embodiment, similarly to that of the second embodiment shown in FIG. 19, the resultant colors of colorants are predicted in accordance with Prediction Formula 1 (S21), the color gamuts are determined, and the areas are calculated in accordance with Prediction Formula 4 (S22), and the combination of colorants for maximizing the color gamut is determined in accordance with Prediction Formula 5 (S23). Prediction Formulae 1 and 4 are the same as those in the second embodiment. Thus, the description is not repeated. Thus, only differences in Prediction Formula 5 between the third and second embodiments are described below.

Prediction Formula 5 of this embodiment is composed of (a) preparation of hypothetical colorants, (b) calculation of the area of a color gamut in accordance with Prediction Formula 4, and (c) selection of a combination of colorants for maximizing the color gamut, similarly to the second embodiment.

Preparation of Colorants

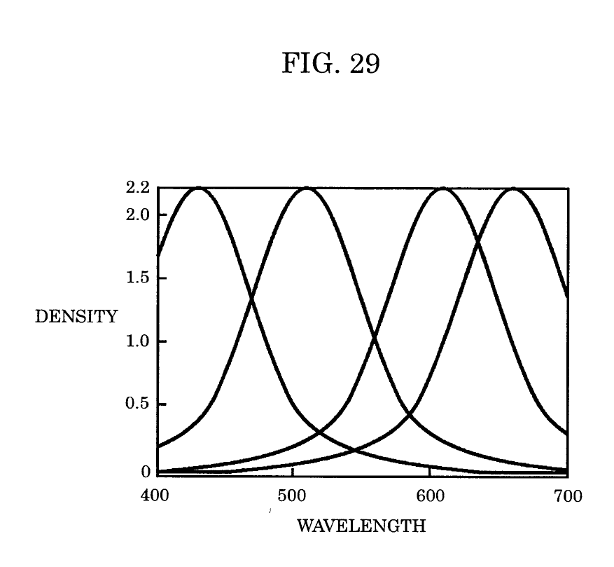

In the third embodiment, four-color colorants are prepared. Thus, for one combination of colorants, it is necessary to define the spectral densities S₁(λ), S₂(λ), S₃(λ), and S₄(λ) of the four colorants (see FIG. 29).

The spectral densities of the colorants are defined in accordance with equation (10) using the spline function C(λ). However, the spectral density is normalized to a maximum density of 2.2, which is different from the case of the above-described equation (10).

The peak position is represented by λ, and the half-width is represented by ω. Then, the spectral density is defined by equation (27) using the spline function C(λ):
S(λ)=f1+0.1×f2+0.1×f3+0.05×f4+0.05×f5 (27)
wherein f1=C(λ−λ₀),
f2=C(λ−λ₀−ω),
f3=C(λ−λ₀+ω),
f4=C(λ−λ₀−2ω), and
f5=C(λ−λ₀+2ω).

More preferably, to adapt the spectral density to the characteristic (spectral density) of a practical colorant, the coefficients (0.1 and 0.05) in equation (27) are adjusted. For example, if it is necessary to form a broad waveform, equation (27) may be adjusted to equation (28). If it is necessary to form a narrow waveform, equation (27) may be adjusted to equation (29):
S(λ)=f1+0.2×f2+0.2×f3+0.1××f4+0.1×f5 (28)
S(λ)=f1+0.05×f2+0.05×f3+0.025×f4+0.025×f5 (29)

Accordingly, the respective peak positions are represented by λ_{1.0}, λ_{2.0}, λ_{3.0}, and λ_{4.0}. The spectral densities S_{1.0}(λ), S_{2.0}(λ) , S_{3.0}(λ) , and S_{4.0}(λ) of the respective colorants are defined by equation (30):
S₁(λ)=C(λ−λ_{1.0})
S₂(λ)=C(λ−λ_{2.0})
S₃(λ)=C(λ−λ_{3.0})
S₄(λ)=C(λ−λ_{4.0}) (30)
wherein 400≦S_{1.0}(λ)<S_{2.0}(λ)<S_{3.0}(λ)<S_{4.0}(λ)≦700.
Selection of Combination of Colorants for Maximizing Color Gamut

The peak positions λ_{1.0}, λ_{2.0}, λ_{3.0}, and λ_{4.0} and the half-widths ω₁, ω₂, ω₃, and ω₄ are varied. Thus, regarding the combinations of the hypothetical colorants, the areas of the color gamuts are calculated. Then, the combination of colorants for minimizing the color gamut is selected. Regarding the area of a color gamut, the calculation is carried out at intervals of L*=10 in the lightness range of L*=40 to L*=90. Thus, the sum of the six calculated areas is taken as the area of the color gamut of the combination of colorants.

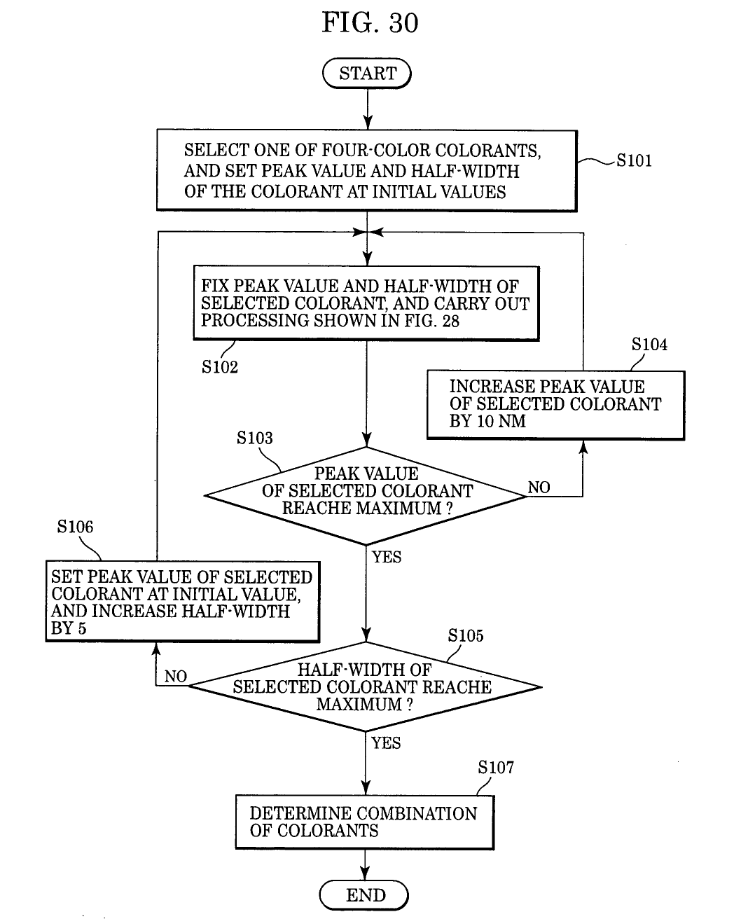

FIG. 30 is a flow chart showing an example of the procedure for selecting the combination of colorants for maximizing the color gamut.

One of the four-color colorants is selected. The peak value of the colorant and the half-value are set at initial values (minimums) (S101). For example, if a colorant having the peak position λ₄ is selected, the initial values of the colorant with the λ₄ are set at λ_{4.0}=620 nm and ω=10.

Then, the processing illustrated in FIG. 28 is executed while the peak values and the half-width of the selected colorant is fixed (S102). In this case, for example, λ_{1.0} is set in the range of 400 nm to 480 nm, λ_{2.0} is set in the range of 470 nm to 550 nm, and λ_{3.0} is set in the range of 550 nm to 630 nm. The half-width is set in the range of 10 to 110.

Then, it is determined whether λ_{4.0} has reached a maximum (e.g., 700 nm) or not (S103). If it is determined that λ_{4.0} has not reached the maximum, the peak value is increased by 10 nm (S104), and the processing returns to step S102. If it is determined that λ_{4.0} has reached the maximum (e.g., 110) (S105), λ_{4.0} is returned to the initial value, and ω_{4.0} is increased by 5 (S106), and the processing returns to step S102.

In the case where both λ_{4.0} and ω_{4.0} have reached the maximums, the combination of the colorants expressed as λ_{max, 1.0,} λ_{max, 2.0,} λ_{max, 3.0,} λ_{max, 4.0,} ω_{max, 1.0}, ω_{max, 2.9}, ω_{max, 3.0}, ω_{max, 4.0}, of the peak positions and the half-widths by which the color gamut is maximized, is taken as the combination of the colorants for maximizing the color gamut (S107).

Modification of Prediction Formula 4

Prediction formula 4 may be composed of the following three elements. These elements are sequentially described below:
(a) Determination of a starting point and an end point
(b) Depiction of a color gamut
(c) Calculation of the area of a color gamut
   Determination of Starting Point and Rnd Point

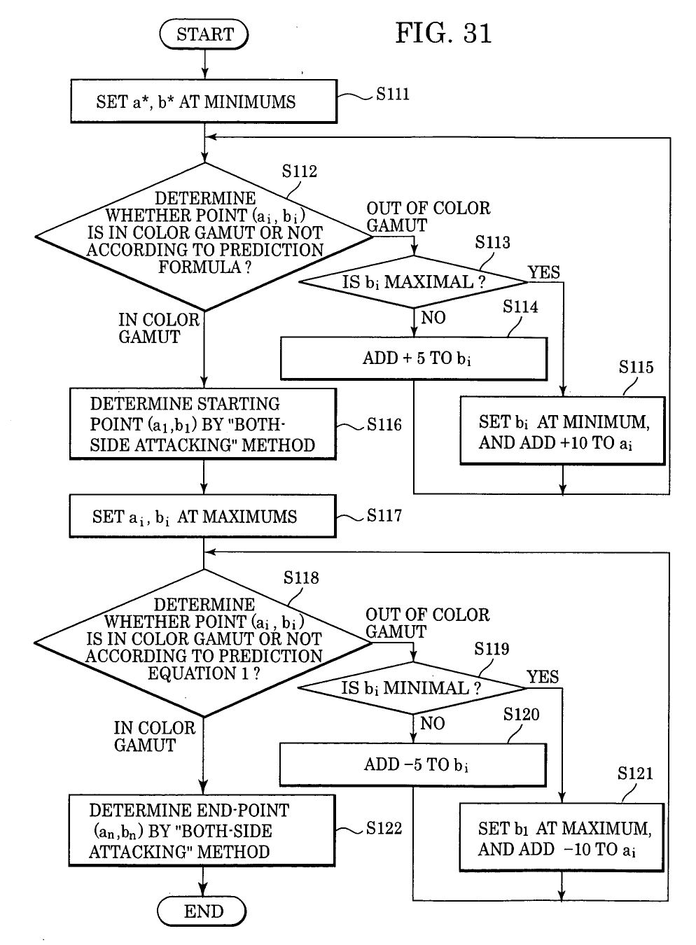

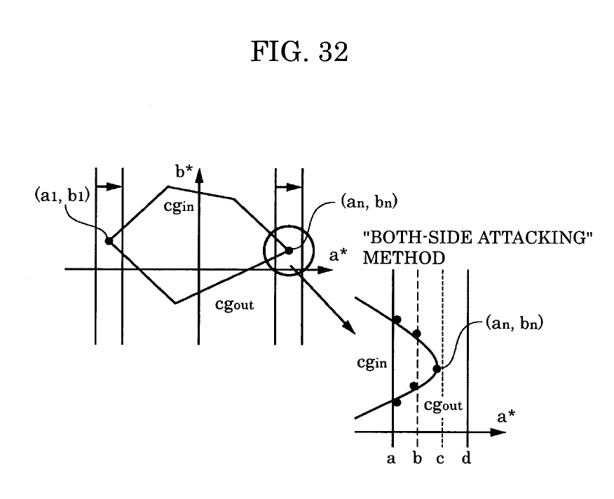

FIG. 31 is a flow chart showing the procedure for determining a starting point and an end point. FIG. 32 illustrates an example of the starting point and the end point. In FIG. 32, cgᵢₙ represents the inside of a color gamut, and cgₒᵤₜ represents the outside of the color gamut.

First, aᵢ and bᵢ are set at minimums (e.g., −120) (S111). It is determined whether the point (aᵢ, bᵢ) is in the color gamut in accordance with Prediction Formula 1 (S112). If the point (aᵢ, bᵢ) is out of the color gamut, it is determined whether bᵢ has a maximum (e.g., 120) or not (S113). If bᵢ is less than the maximum, a predetermined value (e.g., +5) is added to bᵢ (S114), and the processing returns to step S102. If bᵢ has the maximum, bᵢ is set at the minimum, a predetermined value (e.g., +10) is added to aᵢ (S115), and the processing returns to step S112.

If it is determined that the point (aᵢ, bᵢ) is in the color gamut at step S112, the above-described “both-sides attacking method” is executed from the point (aᵢ, bᵢ) as an origin. Thus, the point (a1, b1) on the color gamut boundary is determined. The point (a1, b1) is taken as a starting point (S116).

Subsequently, aᵢ and bᵢ are set at maximums (e.g., 120) (S117). It is determined whether the point (aᵢ, bᵢ) is in the color gamut or not (S118). If the point (aᵢ, bᵢ) is out of the color gamut, it is determined whether bᵢ has a minimum (e.g., −120) or not (S119). If bi exceeds the minimum, a predetermined value (e.g., −5) is added to bᵢ (S120), and the processing returns to step S108. If bᵢ has the minimum, bᵢ is set at the maximum, a predetermined value (e.g., −10) is added to aᵢ(S121), and the processing returns to step S118.

If it is determined that the point is in the color gamut at step S118, the above-described “both-sides attacking” method is carried out from the point (aᵢ, bᵢ) as an origin. Thus, a point (an, bn) on the color gamut boundary is determined. The point (an, bn) is taken as an end point (S122).

Depiction of Color Gamut

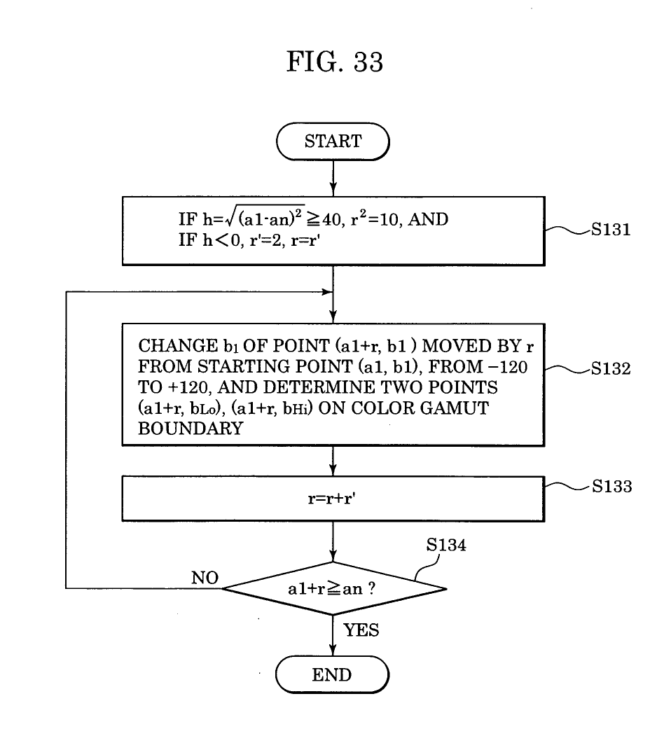

FIG. 33 is a flow chart showing an example of the procedure for depicting a color gamut.

First, the distance h=√(a1−an)² between the starting point (a1, b1) and the end point (an, bn) in the a* direction is calculated. If h≦40, the increment of the movement amount is set at r′=10; if h<40, the increment of the movement amount is set at r′=2. The movement amount r is set at r=r′ (S131).

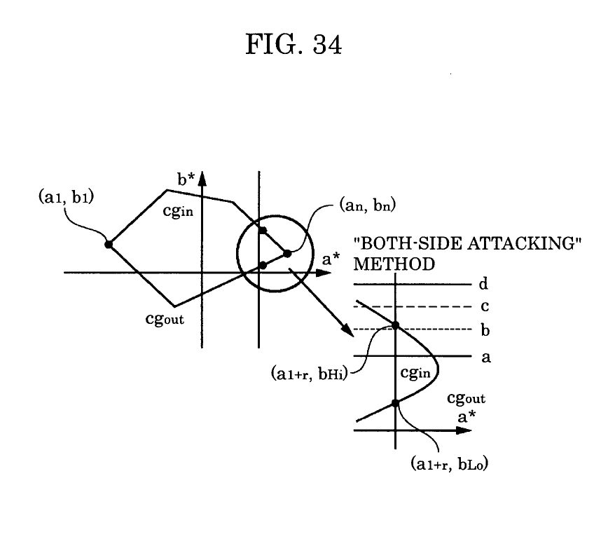

Then, with respect to a point (a1+r, b1) moved from the starting point (a1, b1) by the movement amount r in the a* direction, b1 is changed from −120 to +120, and thereby, two points (a1+r, b_{L0}) and (a1+b, b_{Hi}) are determined (S132) (see FIG. 34). Similarly to the above-described case, Prediction Formula 1 is used to determine whether a point is in the color gamut or not, and the “both-sides attacking” method is employed to determine whether a point is on the color gamut boundary or not.

Subsequently, the movement amount r is set at r=r+r′(S133). It is determined whether a1+r≦ an is effective or not (S134). Steps S132 and S133 are repeated until a1+r≦ an becomes effective.

The movement amount r and the increment r′ may be empirically changed, depending on the characteristics of the colorants (the size and the shape of the color gamut). In the above-description, the starting point (a1, b1) is moved in the a* direction as an example. The starting point (a1, b1) may be moved in the b* direction.

Calculation of Area of Color Gamut

The area of a color gamut is calculated in a manner similar to that in the second embodiment. Thus, the detailed description is not repeated.

Modification of Prediction Formula 5

In the second and third embodiments, for (c) selection of the combination of colorants for maximizing the color gamut in Prediction Formula 5, the round robin method and non-linear optimization techniques are used. However, the simplex method shown in FIG. 21 may be employed.

Modification of Definition of Half-Width

In the second and third embodiments, one type of half-width is defined. However, half-widths ω₁ and ω₂ may be defined for the right and left sides of a peak position, respectively. Thus, the number of the half-width parameters is doubled, so that the spectral density of a colorant becomes nearer to that of an actual colorant. In this case, the spline function is defined by equation (31):
In the case of 0≦|λ|≦ω_{R}
C(λ)={ω_{R}³+3ω_{R}²(ω_{R}−|λ|)+3ω_{R}(ω_{R}−|λ|)²+3(ω_{R}−|λ|)³}/6ω_{R}³
In the case of −ω|λ|≦0,
C(λ)={ω_{L}³+3ω_{L}²(ω_{L}51 λ)+3ω_{L}(ω_{L}−|λ|)²+3(ω_{L}−|λ|)³}6ω_{L}³
In the case of ω_{R<|λ|≦}2ω_{R}
C(λ)=(2ωᵣ−|λ|)/6ω_{R}³
In the case of −2ω_{L}<|λ|≦−ω_{L}
C(λ)=(2ω_{L}−|λ|)/6ω_{L}³
In the case of λ<−2ωL, λ>2ωR,
C(λ)=0 (31)
wherein ω represents the half-width, i.e., a coefficient for determining the width of a spectral density, and
λ is the wavelength (nm).

The spectral density is normalized to a maximum density of 2.0.

### Fourth Embodiment

The color processing according to a fourth embodiment of the present invention is described below. In the fourth embodiment, elements having the same constitutions as those in the first to third embodiments are designated by the same reference numerals, and the detailed description is not repeated.

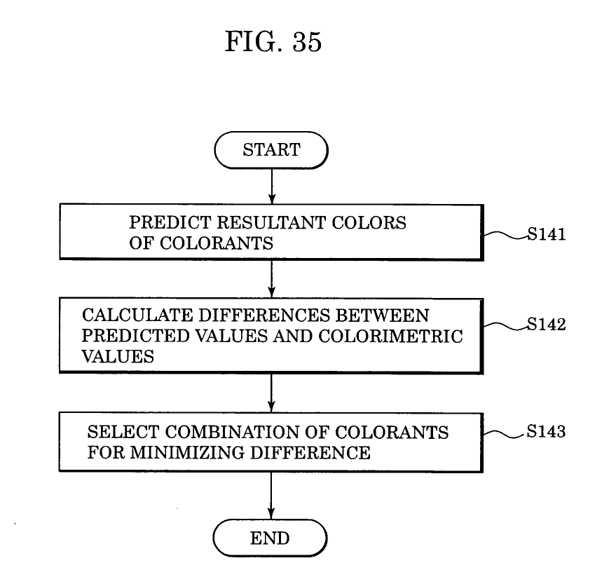

In the fourth embodiment, the combination of three-color colorants for minimizing the difference between visually perceived colors under different light sources is determined. In other words, the determination aims at developing colorants that can reproduce a color from the standpoint of the spectral distribution. FIG. 35 is a flow chart showing the processing according to the fourth embodiment.

First, the resultant colors of colorants are predicted according to Prediction Formula 6 (S141). The differences between the predicted colors and the colorimetric values are calculated (S142). The combination of colorants for minimizing the difference is selected in accordance with Prediction Formula 7 (S143).

Prediction Formula 6

Prediction Formula 6 has the following features. That is,
(a) The resultant colors of colorants are calculated in accordance with Prediction Formula 1. Specifically, the spectral reflectances of the combinations of colorants are calculated.
(b) The spectral reflectance R′(λ) of an object to be reproduced with colorants is calculated. The Simplex method illustrated in FIG. 21 is used. xᵢ represents the amounts of combined colorants, f(xi) represents Prediction Formula 1, D65 is used as a light source, and the angle of view is set at 2°.
(c) The differences between the spectral reflectance R′(λ) and the calorimetric values R(λ) of the object are calculated. Specifically, the effective spectral reflectance errors RMSobj are calculated in accordance with equation (9).

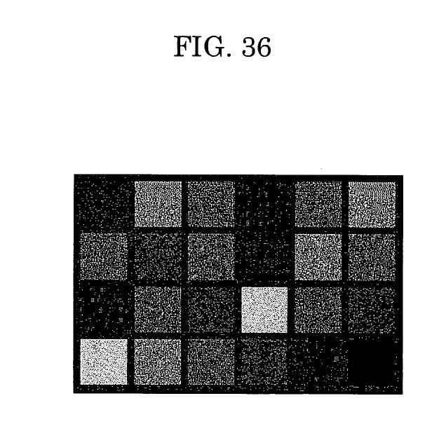

As the object, a Macbeth color chart (24 colors) shown in FIG. 36 is used.

Prediction Formula 7

Prediction Formula 7 is used to determine the combination of colorants for minimizing the effective spectral reflectance error RMSobj using the modified Powell method.

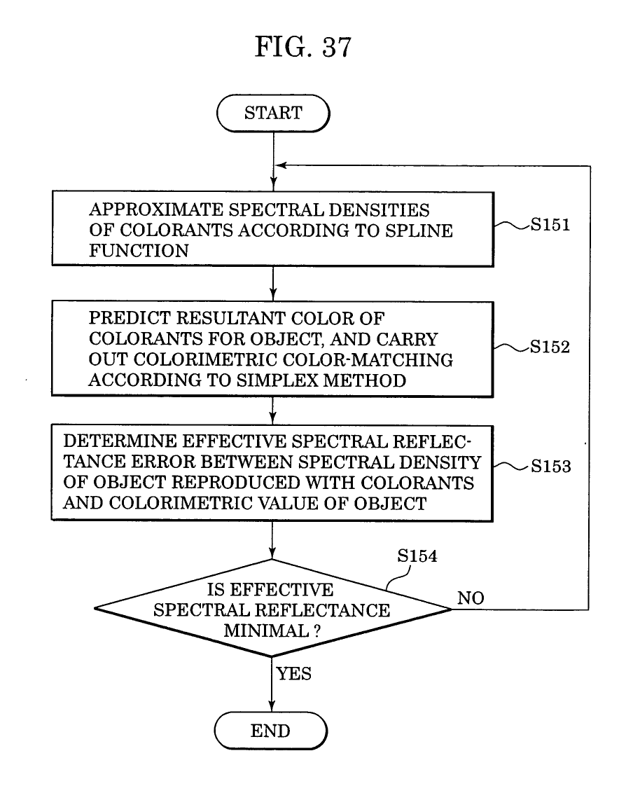

FIG. 37 is a flow chart showing the processing in accordance with Prediction Formula 7.

First, combinations of colorants are prepared in accordance with the spline function of equation (31), into which optional parameters are substituted (S151). With respect to the respective colors of the Macbeth color chart, the resultant colors of the prepared combined colorants are predicted by the KM model. The spectral reflectances R′(λ) of the object to be reproduced with the combination of colorants are calculated (calorimetric color matching by the Simplex method) (S152). In this case, D65 is used as a light source, as described above.

Then, the effective spectral reflectance errors between the spectral reflectances R′(λ) and the calorimetric values R(λ) of the Macbeth color chart are determined in accordance with equation (9) (S153). It is determined whether the effective spectral reflectance error RMSobj is minimized or not, based on a constant (e.g., the above-described min or the like) for ensuring the termination of the processing (S154). Steps S151 to S154 are repeated until it is determined that the RMSobj is minimal.

### Fifth Embodiment

Hereinafter, the color processing according to a fifth embodiment of the present invention is described. In the fifth embodiment, elements having the same constitutions as those in the first to third embodiment are designated by the same reference numerals, and the detailed description is not repeated.

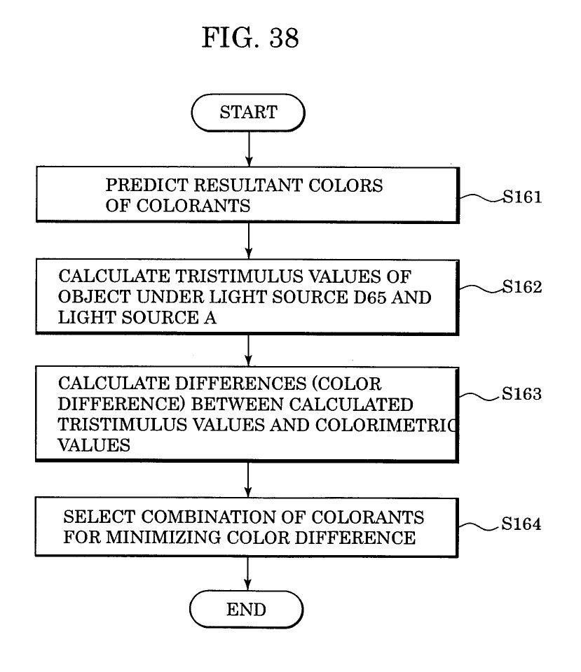

In the fifth embodiment, the combination of three-color colorants for minimizing the difference between visually perceived colors under different light sources is determined. In particular, the combination of colorants for minimizing the variation of the visually perceived colors of a grey balance under different light sources is determined. FIG. 38 is a flow chart showing the processing of the fifth embodiment.

First, the resultant colors of colorants are predicted in accordance with Prediction Formula 8 (S162). The tristimulus values XYZ of an object under a light source D65 and a light source A are calculated (S162). The differences (color differences) between the predicted tristimulus values and the calorimetric values are calculated. The combination of colorants for minimizing the difference (color difference) is selected in accordance with Prediction Formula 9 (S164).

Prediction Formula 8

Prediction Formula 8 has the following features:
(a) The resultant colors of colorants are calculated in accordance with Prediction Formula 1. Specifically, the spectral reflectance R′(λ) and the tristimulus values XYX are calculated from the amounts of combined colorants.
(b) The spectral reflectances R′(λ) and the tristimulus values X_{D65}Y_{D65}Z_{D65} of an object to be reproduced with colorants are calculated. The Simplex method shown in FIG. 21 is used. xᵢ represents the amounts of combined colorants, f(xᵢ) represents Prediction Formula 1, the light source is D65, and the angle of view is 2°.
(c) The tristimulus values X_{A}Y_{A}Z_{A} under a light source A are calculated based on the spectral reflectances R′(λ).
(d) The difference between the tristimulus values X_{A}Y_{A}Z_{A} and X_{D65}Y_{D65}Z_{D65} is calculated.

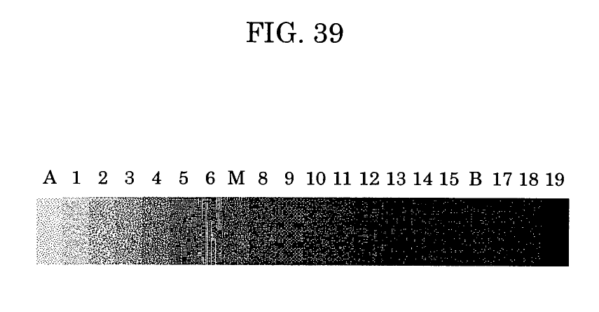

As the object, the grey chart shown in FIG. 39 (20 colors) is used.

Prediction Formula 9

Prediction Formula 9 is used to determine the combination of colorants for minimizing the color difference using the modified Powell method illustrated in FIG. 16.

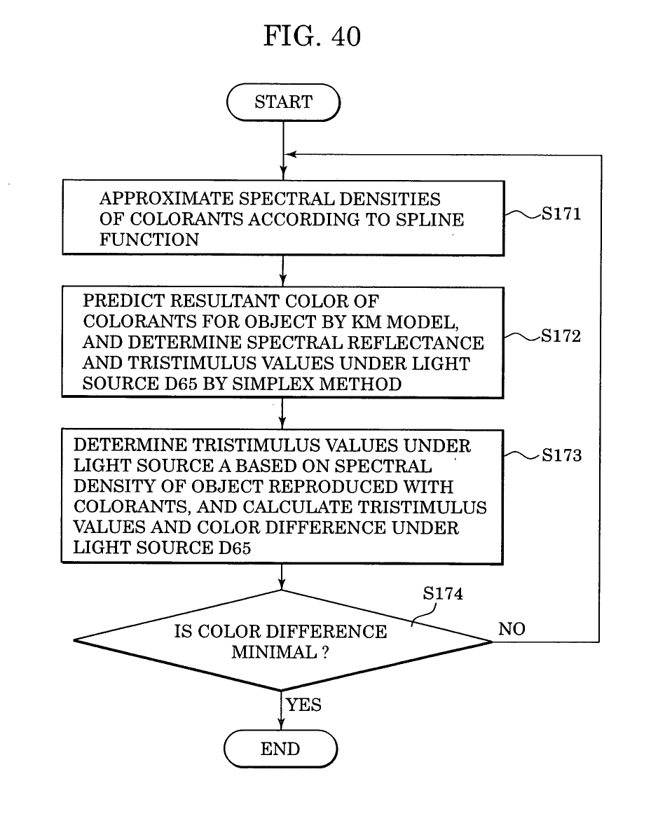

FIG. 40 is a flow chart showing the processing carried out in accordance with Prediction Formula 9.

First, the combinations of colorants are prepared in accordance with the spline function of equation (31), into which optional parameters are substituted (S161). With the respective colors of the grey chart, the resultant colors of the prepared colorants are predicted by the KM model. The colorimetric color matching is carried out by the Simplex method. The tristimulus values X_{D65}Y_{D65}Z_{D65} and the spectral reflectance R′(λ) under a light source D65 are calculated (S162).

Subsequently, the tristimulus values X_{A}Y_{A}Z_{A} under a light source A are calculated based on the spectral reflectance R′(λ). The color difference ΔE₉₄ between the tristimulus values X_{A}Y_{A}Z_{A} and X_{D65}Y_{D65}Z_{D65} is calculated in accordance with the equation (8) (S163). It is determined whether the color difference ΔE₉₄ is minimized or not, based on a constant (e.g., the above-described min or the like) for assuring the termination of the processing (S164). The processing of steps S161 to S164 is repeated until it is determined that the color difference ΔE₉₄ is minimized.

### Other Embodiments

The present invention may be applied to a system comprising plural devices (e.g., a host computer, interface devices, a reader, a printer, and so forth), or to a single apparatus (e.g., a copying machine, a facsimile device, or the like).

Also, the object of the present invention can be achieved by supplying a storage (or recording) medium having program code of software for realizing the functions described in the embodiments recorded therein, whereby a computer of a system or apparatus (CPU or MPU) reads the program code stored in the storage medium to execute the program. In this case, the program code itself read out from the storage medium realizes the functions described in the embodiments. Thus, the storage medium having the program code stored therein constitutes the present invention. As described above, the computer reads the program code and executes it, so that the functions described in the embodiments are realized. In addition, an operating system (OS) or the like running on a computer may execute a part of or the whole of the actual processing, based on instructions of the program code, and by this processing, the functions described in the embodiments are realized.

In the case where the present invention is applied to the above-described storage medium, the program code corresponding to the above-described flow chart is stored in the storage medium.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A method of processing color useful for determination of a combination of colorants by which the quality of a printed image can be prevented from being deteriorated due to a color difference generated by variations in density, comprising:
a first step of calculating the resultant colors of colorants;
a second step of calculating a color difference generated by the variations in density; and
a third step of determining the combination of colorants corresponding to the color difference generated by the variations in density.

2. A method of processing color comprising:
a first step of calculating the resultant colors of colorants;
a second step of calculating the spectral reflectance of a color chart to be reproduced with the colorants, based on the calculation of the resultant colors of the colorants in the first step;
a third step of calculating the difference between the spectral reflectance obtained in the second step and the spectral reflectance of the color chart obtained by a colorimetric method in advance; and
a fourth step of determining the combination of colorants in response to said difference.

3. A method of processing color comprising:
a first step of calculating the resultant colors of colorants;
a second step of calculating the spectral reflectance and the first tristimulus values under a first light source of a color chart to be reproduced with colorants, based on the calculation of the resultant colors of the colorants in the first step;
a third step of calculating the second tristimulus values under a second light source of the color chart to be-reproduced with the colorants, based on the spectral reflectance obtained in the second step;
a fourth step of calculating the differences between the first tristimulus values and the second tristimulus values; and
a fifth step of determining the combination of colorants in response to said difference.

4. A method of processing color according to claim 1, wherein in the first step, the spectral reflectance R_{λ}(λ) of a combination of primary-color colorants is calculated in accordance with the following Kubelka-Munk theoretical equation;
R_{λ}(λ)=R_{λ,p}(λ)·exp {−2(Σᵢ·cᵢ·k_{80,i})}, and
k_{λ,i}=0.5·ln {R_{λ,i}(λ)R_{λ,p}(λ)},
wherein R_{λ,i}(λ) is the spectral reflectance of the primary-color colorants;
R_{λ,p} is the spectral reflectance of a recording medium;
c is the density of the primary-color colorants; and
k is the absorption coefficient of the primary-color colorants.

5. A method of processing color according to claim 1, wherein the first step comprises:
a step of compensating for dot-gains of the primary color colorants in accordance with the following modified Kubelka-Munk theoretical equation:
D′_{λi}(λ)=1.0−{1.0−D_{λi}(λ)}^{b},
b=f(c), and
R′_{λ,i}(λ)=10^{-t}, t=D′_{λ,i}(λ),
wherein D′_{λ,i}(λ) is the spectral density of the primary-color colorants;
D_{λ,i}(λ) is the spectral density of the three-color colorants after the compensation; and
R′_{λ,i}(λ) is the spectral reflectance of the primary-color colorants after the compensation; and
a step of calculating the spectral reflectance R_{λ}(λ) of said combination of the primary-color colorants in accordance with the following Kubelka-Munk theoretical equation;
R_{λ}(λ)=R_{λ,p}(λ)·exp {−2(Σᵢ·cᵢ·k_{λ,i})} and
k_{λ,i}=−0.5·ln {R′_{λi}(λ)R_{λ,p}(λ)},
wherein R_{λ,p} is the spectral reflectance of a recording medium;
c is the density of the primary-color colorants; and
k is the absorption coefficient of the primary-color colorants.

6. A method of processing color according to claim 1, wherein in the first step, the spectral reflectance R_{λ}(λ) of the primary-color colorants is calculated in accordance with the following Williams and Clapper theoretical equation:
R(λ)=0.193T^{2.13}[{½R_{B}(λ)}−∫₀^{n/2}T² secθr_{θ sin θ cos θ}dθ]⁻¹,
and
R_{B}(λ)=R_{λp}(λ)R(λ),
wherein T is the spectral transmittance of a colorant-absorption layer of a recording medium;
R_{B}(λ) is the spectral reflectance of the base-surface of the recording paper;
θ is the reflection angle of light reflected from the base surface of the recording medium;
r_{θ} is an internal Fresnel reflectance with respect to the reflection angle; and
R_{λ,p} is the spectral reflectance of the recording medium.

7. A method of processing color according to claim 1, wherein in the second step, the width of the variation of density is determined, the maximums and the minimums of the densities of colorants, obtained by addition of the width of the variation of density to the maximum densities of the colorants, are calculated, and a color difference between the maximums and the minimums are calculated.

8. A method of processing color according to claims 1, wherein in the third step, the combination of the colorants for minimizing the color difference generated by the variation of density is determined according to a non-linear optimization technique.

9. A color processing device for determining the combination of colorants by which deterioration of the quality of a printed image can be minimized, the deterioration of the quality of the printed image being generated due to a color difference by variations in density, comprising:
first unit adapted to calculate the resultant colors of the colorants;
second unit adapted to calculate the color difference generated by the variations in density; and
third unit adapted to determine the combination of colorants corresponding to the color difference generated variations in density.

10. A color processing device for determining the combination of colorants for minimizing the difference between visually sensed colors thereof under different light sources, comprising:
first unit adapted to calculate the resultant colors of colorants;
second unit adapted to calculate the spectral reflectance of a color chart to be reproduced with the colorants, based on the calculation of the resultant colors of the colorants in the first unit; and
third unit adapted to calculate the difference between the spectral reflectance obtained by the second unit and the spectral reflectance of the color chart obtained by colorimetry in advance, and determine the combination of colorants in response to said difference.

11. A color processing device for determining the combination of colorants with which the variation of grey balance occurring due to different light sources is minimized, comprising:
first unit adapted to calculate the resultant colors of colorants;
second unit adapted to calculate the spectral reflectance and the first tristimulus values under a first light source of a color chart to be reproduced with the colorants, based on the calculation of the resultant colors carried out by the first unit;
third unit adapted to calculate the second tristimulus values under a second light source of the color chart to be reproduced with the colorants, based on the spectral reflectance calculated by the second unit; and
fourth unit adapted to calculate the differences between the first tristimulus values and the second tristimulus values and determine the combination of colorants in response to the difference.

12. A program for controlling an information-processing device so that the color processing specified in claim 1 is realized.

13. A program for controlling an information-processing device so that the color processing specified in claim 2 is realized.

14. A program for controlling an information-processing device, so that the color processing specified in claim 3 is realized.
